(19) United States
(12) Patent Application Publication
(10) Pub. No.: US 2021/0276708 A1
(43) Pub. Date: Sep. 9, 2021

(54) SPLIT-TILTWING AIRCRAFT AND RELATED METHODS

(71) Applicant: Aurora Flight Sciences Corporation, a subsidiary of The Boeing Company, Manassas, VA (US)

(72) Inventor: Luis Gonzalez, Cambridge, MA (US)

(21) Appl. No.: 16/808,223

(22) Filed: Mar. 3, 2020

(51) Int. Cl. B64C 29/00; B64C 21/02; B64C 3/38

(52) U.S. Cl. CPC B64C 29/0033; B64C 3/385; B64C 21/02

(57) ABSTRACT

Split-tiltwing aircraft and related methods. The aircraft comprise a wing assembly comprising a forward wing segment and a rear wing segment. The wing assembly is configured to be transitioned among a forward thrust configuration, in which the forward and rear wing segments define a continuous airfoil shape, and a plurality of pitched thrust configurations, in which the forward and rear wing segments are spaced apart. The forward wing segment is configured to be tilted among a forward thrust position and a plurality of pitched positions. The methods comprise controlling elevation of the aircraft by controlling vectored thrust from propulsion units, and transitioning the aircraft to a cruise configuration by tilting the forward wing segment from a pitched position to a forward thrust position, in which the forward and rear wing segments define the continuous airfoil shape, and supplying forward vectored thrust to the aircraft with the propulsion units.

### FIELD

The present disclosure generally relates to tiltwing aircraft.

### BACKGROUND

In the aviation industry, there is a strong and growing interest for aircraft that can take off and land without the use of large runways. For example, various military and urban air mobility operations look to utilize aviation within environments that do not offer the runway lengths needed for takeoff and landing with conventional fixed-wing aircraft. Unlike conventional, fixed-wing aircraft, vertical takeoff and landing (VTOL) aircraft can take off and land vertically, do not need a runway, and thus may be well suited for these environments. Several types of VTOL aircraft exist, including helicopters, tiltrotor aircraft, and tiltwing aircraft. Generally speaking, VTOL aircraft utilize some form of propulsion system, such as rotors, propellers, or vectored jets, to generate vertical thrust in the aircraft and permit vertical takeoff.

Some types of VTOL aircraft can be transitioned from a vertical flight mode, in which the propulsion system generates thrust in a generally vertical direction, to a cruising mode in which the propulsion system generates thrust in a generally horizontal direction. More specifically, unlike helicopters, which typically are wingless, tiltwing aircraft and some tiltrotor aircraft include wings that are utilized to generate lift in the aircraft during horizontal flight or while the aircraft is in the cruising mode. In conventional tiltwing aircraft, rotors or propellers are fixed to a tiltwing, and the entire unit is tilted to a generally horizontal orientation during horizontal or cruising flight and to a generally vertical orientation during vertical flight. In contrast, tiltrotor aircraft may include a fixed wing while having rotors or propellers that are tilted to a generally vertical orientation during vertical flight and to a generally horizontal orientation during horizontal or cruising flight.

While tiltwing aircraft and winged tiltrotor aircraft tend to be more efficient, and can achieve higher cruising speeds relative to helicopters, both of these VTOL aircraft have several drawbacks. For example, during vertical flight, the rotors in winged tiltrotor aircraft typically are oriented such that the slipstreams generated by the rotors are directed at surfaces of the wing, which can significantly reduce thrust efficiency. In general, tiltwing aircraft are not as prone to wing interference as winged tilt rotor aircraft. However, tiltwing aircraft often are compromised by unsteady airloads caused by airflow separation on the wing as it is tilted between vertical and horizontal flight modes. Additionally, tiltwing aircraft tend to be particularly vulnerable to crosswinds and gusts during vertical flight due to the large frontal area that is created by the wing being tilted vertically. Thus, a need exists for VTOL aircraft that do not lose thrust efficiency to wing interference and that are more aerodynamically stable during vertical flight, horizontal flight, and the transition therebetween.

### SUMMARY

Split-tiltwing aircraft and related methods are disclosed herein. The aircraft comprise an airframe comprising a wing assembly that comprises a forward wing segment and a rear wing segment, in which the forward wing segment is positioned forward of the rear wing segment within the wing assembly. The wing assembly is configured to be transitioned among a forward thrust configuration, in which the forward wing segment and the rear wing segment define a continuous airfoil shape and a plurality of pitched thrust configurations, in which the forward wing segment and at least a portion of the rear wing segment are spaced apart. The forward wing segment is pivotally coupled within the airframe and configured to be selectively tilted among a plurality of forward wing segment tilt positions that comprises a forward wing segment forward thrust position that corresponds to the forward thrust configuration of the wing assembly, and a plurality of forward wing segment pitched positions that correspond to the plurality of pitched thrust configurations of the wing assembly.

The methods comprise controlling elevation of the aircraft by controlling vectored thrust induced in the aircraft by one or more propulsion units, and transitioning the aircraft to a cruise configuration by selectively tilting the forward wing segment from a forward wing segment pitched position to a forward wing segment forward thrust position, in which the forward wing segment and the rear wing segment define the continuous airfoil shape, and supplying thrust to the aircraft with the one or more propulsion units in a forward thrust vector that corresponds to the forward thrust position of the forward wing segment.

### BRIEF DESCRIPTION OF THE DRAWINGS

FIG. 1 is a diagram that schematically represents aircraft with a wing assembly shown in a forward thrust configuration, according to the present disclosure.

FIG. 2 is a diagram that schematically represents the aircraft of FIG. 1 with the wing assembly shown among the pitched thrust configurations, according to the present disclosure.

FIG. 3 is a schematic representation of example wing assemblies according to the present disclosure, shown in a forward thrust configuration.

FIG. 4 is a schematic representation of the example wing assemblies of FIG. 3, shown in a pitched thrust configuration, according to the present disclosure.

FIG. 5 is a schematic representation of example wing assemblies, according to the present disclosure, shown in a forward thrust configuration.

FIG. 6 is a schematic representation of example wing assemblies of FIG. 5, shown in a pitched thrust configuration, according to the present disclosure.

FIG. 7 is a schematic representation of the example wing assemblies of FIG. 5 shown in a pitched thrust configuration, according to the present disclosure.

FIG. 8 is an isometric view of an example aircraft, according to the present disclosure, with a wing assembly shown in a forward thrust configuration.

FIG. 9 is another isometric view of the example aircraft of FIG. 8, with the wing assembly shown in a pitched thrust configuration, according to the present disclosure.

FIG. 10 is another isometric view of the example aircraft of FIG. 8, with the wing assembly shown in a pitched thrust configuration, according to the present disclosure.

FIG. 11 is an isometric view of an example aircraft, according to the present disclosure, with a wing assembly shown in a forward thrust configuration.

FIG. 12 is another isometric view of the example aircraft of FIG. 11, with the wing assembly shown in a pitched thrust configuration, according to the present disclosure.

FIG. 13 is an isometric view of an example aircraft, according to the present disclosure, with a wing assembly shown in a forward thrust configuration.

FIG. 14 is another isometric view of the example aircraft of FIG. 13, with the wing assembly shown in a pitched thrust configuration, according to the present disclosure.

FIG. 15 is a diagram that schematically represents an example electrical system that may be utilized in aircraft, according to the present disclosure.

FIG. 16 is a flow chart schematically representing methods, according to the present disclosure.

### DESCRIPTION

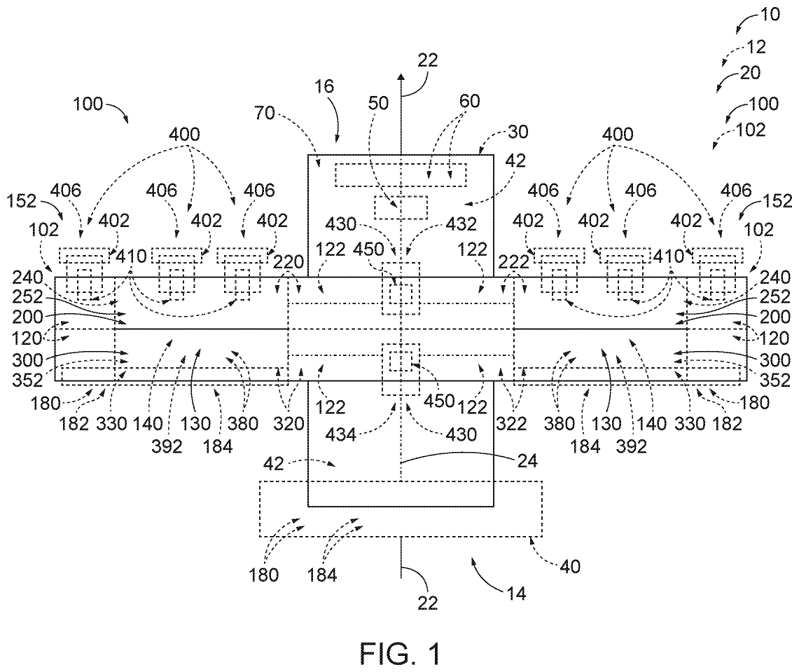

Split-tiltwing aircraft and related methods are disclosed herein. FIGS. 1-16 provide examples of aircraft 10, electrical systems 70 for aircraft 10, and related methods 500 for operating aircraft 10, according to the present disclosure. Elements that serve a similar, or at least a substantially similar, purpose are labelled with like numbers in each of FIGS. 1-16, and these elements may not be discussed in detail herein with reference to each of FIGS. 1-16. Similarly, all elements may not be labelled in each of FIGS. 1-16, but reference numbers associated therewith may be utilized herein for consistency. Elements, components, and/or features that are discussed herein with reference to one or more of FIGS. 1-16 may be included in and/or utilized with any of FIGS. 1-16 without departing from the scope of the present disclosure.

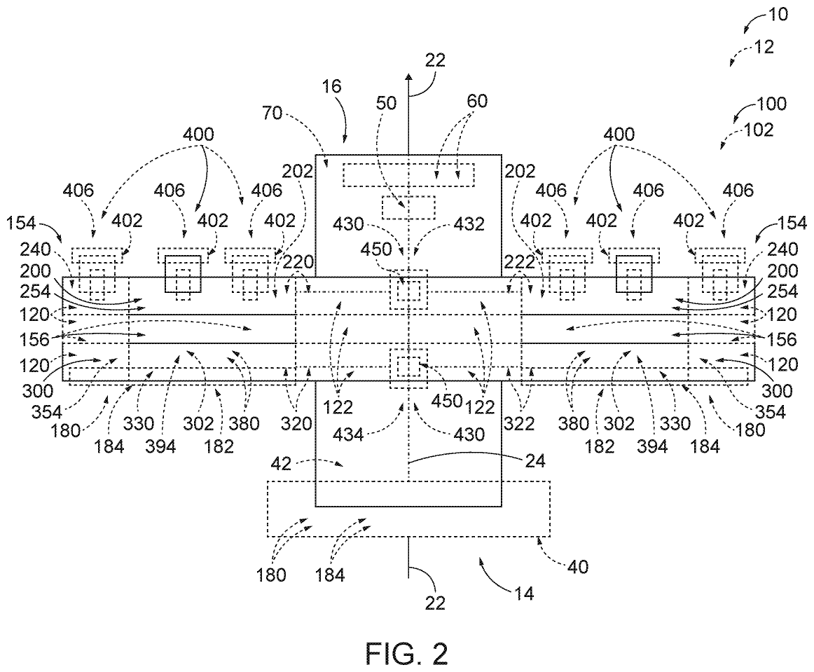

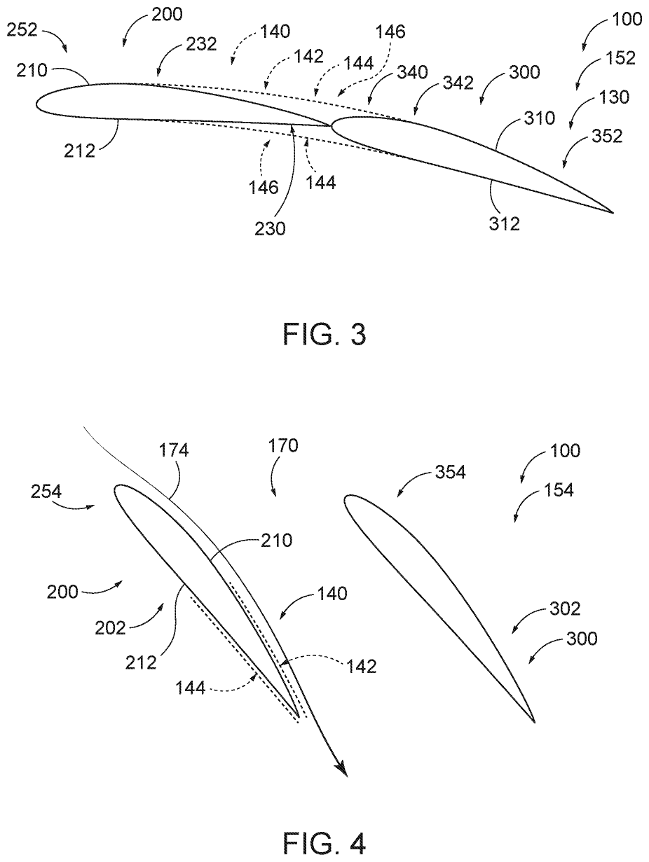

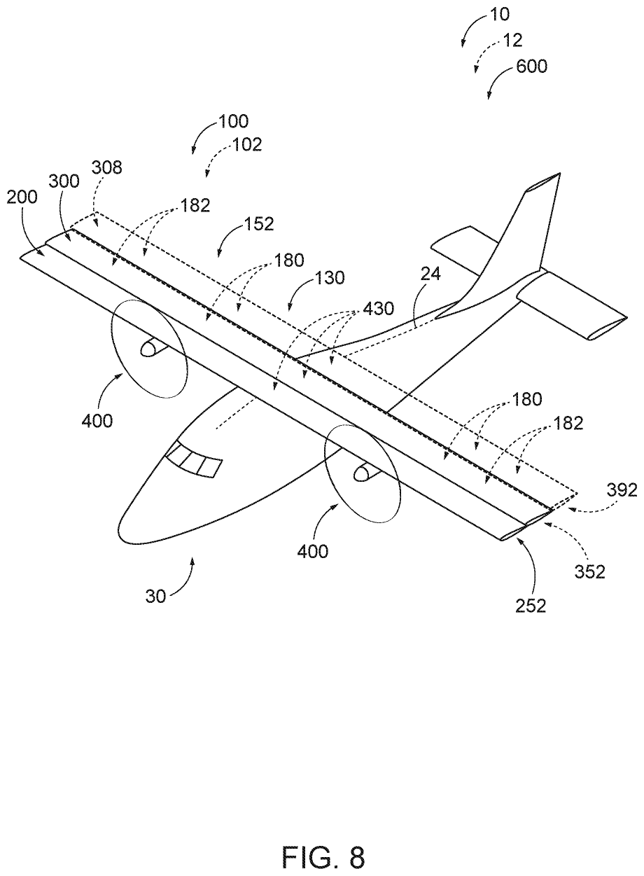

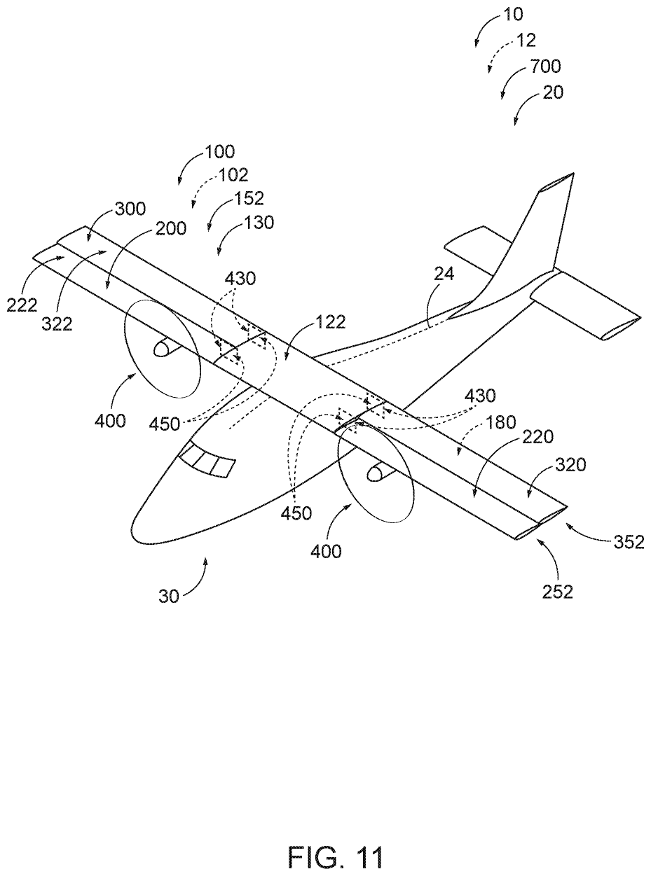

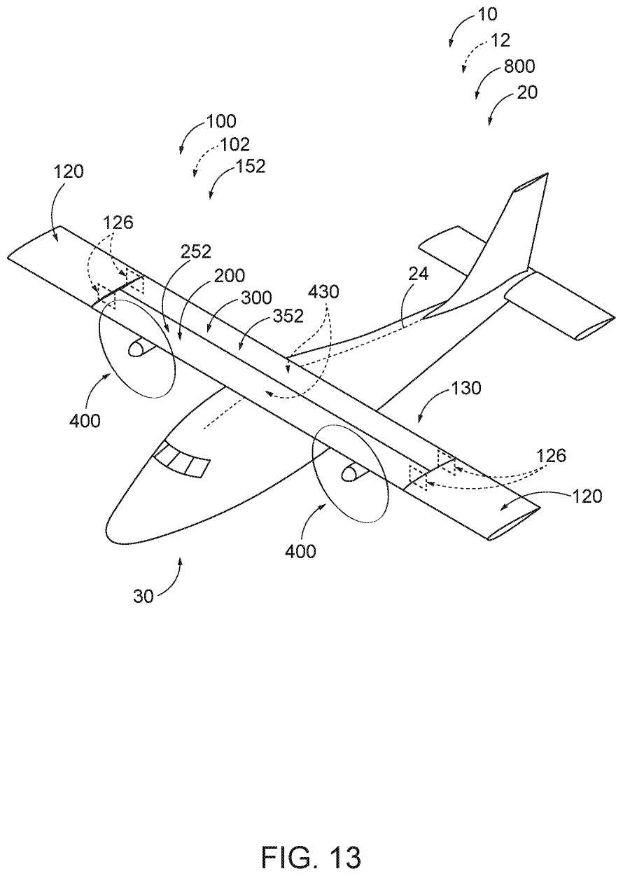

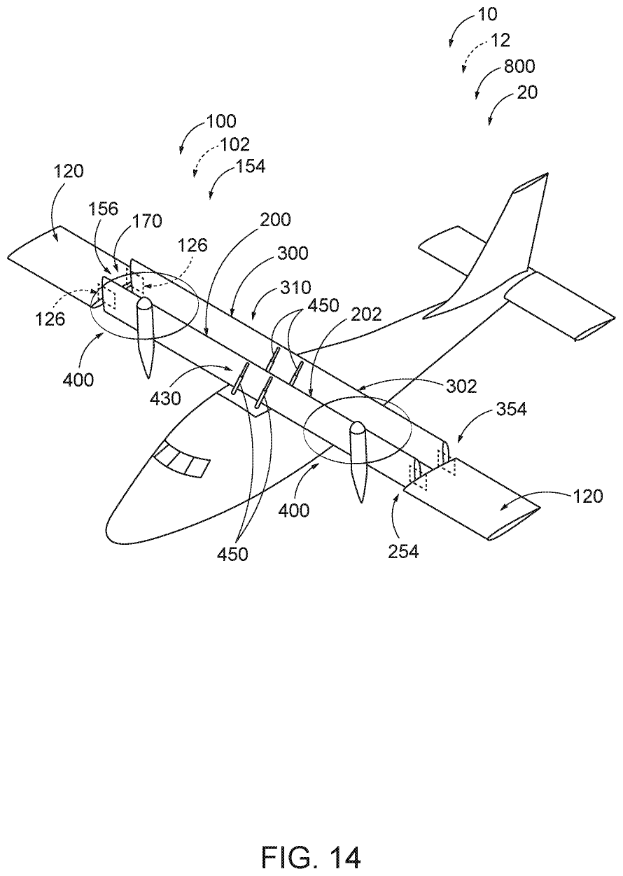

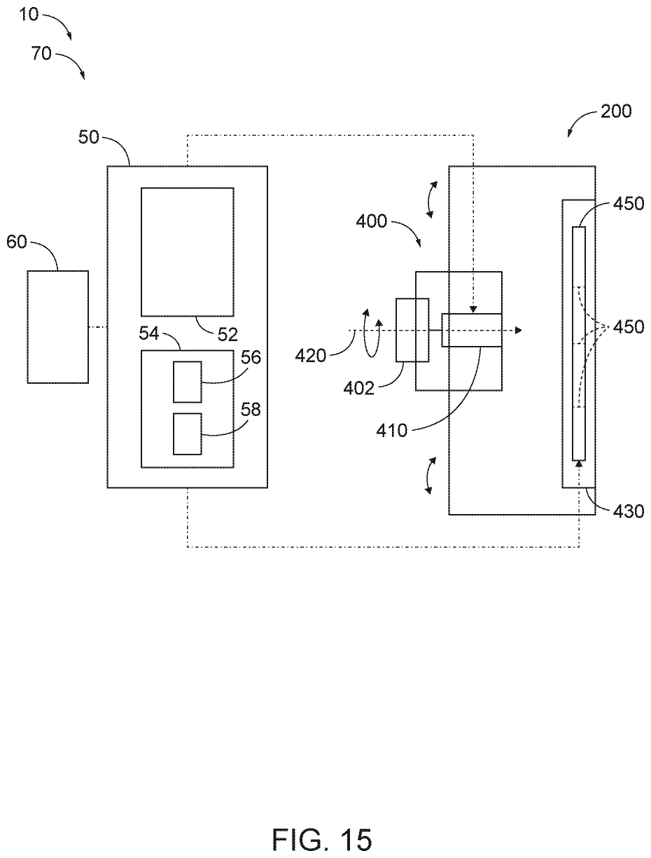

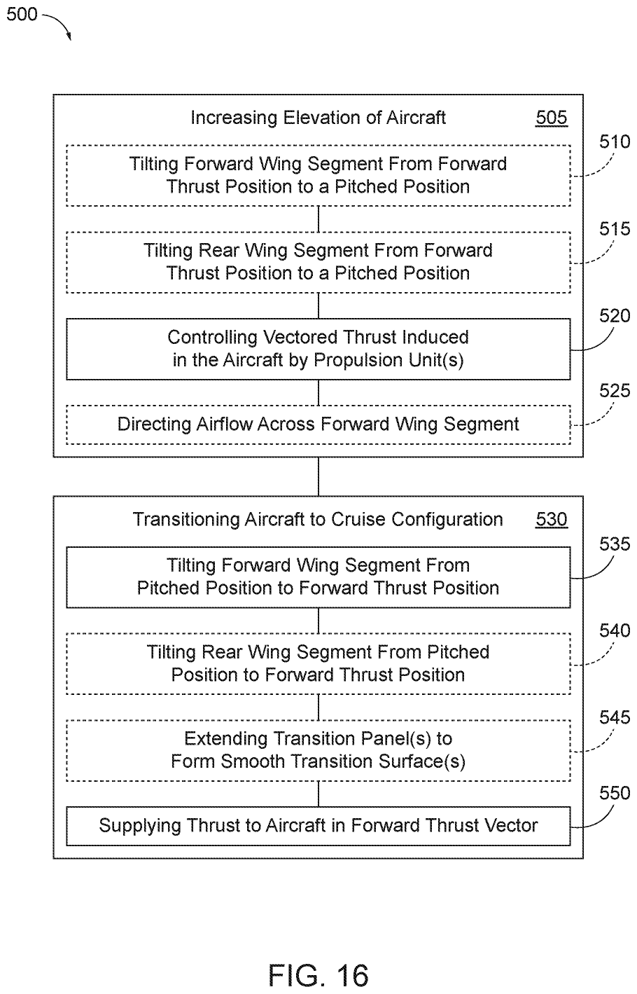

FIGS. 1-2 schematically represent aircraft 10 according to the present disclosure, FIGS. 3-7 schematically illustrate examples of wing configurations that may be present in and/or utilized with aircraft 10, FIGS. 8-10 illustrate less schematic examples of aircraft 10 indicated at, and referred to herein, as aircraft 600, FIGS. 11-14 illustrate less schematic examples of aircraft 10 indicated at, and referred to herein, as aircraft 700, and FIGS. 13-14 illustrate less schematic examples of aircraft 10 indicated at, and referred to herein, as aircraft 800. FIG. 15 illustrates examples of electrical systems of aircraft 10, and FIG. 16 provides a flowchart schematically representing examples of methods 500, such as methods of operation of an aircraft, according to the present disclosure. Generally, in FIGS. 1-2, elements that are likely to be included in a given (i.e., particular) example of aircraft 10 are illustrated in solid lines, while elements that are optional to a given example of aircraft 10 are illustrated in dashed lines. However, elements that are illustrated in solid lines in FIGS. 1-2 may be omitted from a particular example of aircraft 10 without departing from the scope of the present disclosure. The following discussion concentrates on the schematic representation of aircraft 10 in FIGS. 1-7; however, where appropriate and to facilitate understanding of aircraft 10, reference to the illustrative, non-exclusive examples of aircraft 600, 700, and 800 in FIGS. 8-10, 11-12, and 13-14, respectively, are made. Example aircraft 600, 700, and 800 are non-exclusive and do not limit aircraft 10 to the illustrated embodiments of FIGS. 8-14. That is, aircraft 10 according to the present disclosure may incorporate any number of the various aspects, configurations, characteristics, properties, etc. of aircraft 10 that are illustrated in and discussed with reference to the schematic representations of FIGS. 1-7 and 14 and/or the embodiments of FIGS. 8-14, as well as variations thereof, without requiring the inclusion of all such aspects, configurations, characteristics, properties, etc. For the purpose of brevity, each discussed component, part, portion, aspect, region, etc. or variants thereof may not be discussed, illustrated, and/or labeled with respect to aircraft 600, 700, and 800; however, it is within the scope of the present disclosure that the discussed features, variants, etc. of aircraft 10 may be utilized with aircraft 600, 700, and 800. Likewise, the specific illustrated and discussed aspects of aircraft 600, 700, and 800 may be utilized with other aircraft 10 according to the present disclosure.

With initial reference to FIGS. 1-2, aircraft 10 comprises an airframe 20 having a wing assembly 100 that includes a forward wing segment 200 and a rear wing segment 300, in which forward wing segment 200 is positioned within wing assembly 100 forward of rear wing segment 300. Wing assembly 100 is configured to be selectively transitioned among a forward thrust configuration 152 and a plurality of pitched thrust configurations 154. FIG. 1 schematically illustrates aircraft 10 with wing assembly 100 in forward thrust configuration 152, while FIG. 2 schematically illustrates aircraft 10 with wing assembly 100 among plurality of pitched thrust configurations 154. As shown in FIG. 1, when wing assembly 100 is in forward thrust configuration 152, forward wing segment 200 and rear wing segment 300 define a continuous airfoil shape 130. Stated another way, wing assembly 100 may be described as forming continuous airfoil shape 130 while oriented in forward thrust configuration 152. As shown in FIG. 2, when wing assembly 100 is among pitched thrust configurations 154, forward wing segment 200 is spaced apart from at least a portion of rear wing segment 300. In some examples, when wing assembly 100 is among pitched thrust configurations 154, forward wing segment 200 and optionally rear wing segment 300 define discrete airfoil shapes. More specifically, in some examples, forward wing segment 200 defines a forward wing segment airfoil 202 when wing assembly 100 is among pitched thrust configurations 154. Similarly, in some examples, rear wing segment 300 defines a rear wing segment airfoil 302 when wing assembly 100 is among pitched thrust configurations 154. In some examples, forward wing segment airfoil 202 and/or rear wing segment airfoil 302 are configured to induce lift in the aircraft, such as when wing assembly 100 is among pitched thrust configurations 154.

With continued reference to FIGS. 1-2, forward wing segment 200 is pivotally coupled within airframe 20 and is configured to be tilted among a plurality of forward wing segment tilt positions. More specifically, as shown in FIG. 1, the forward wing segment tilt positions comprise a forward wing segment forward thrust position 252 that corresponds to forward thrust configuration 152 of wing assembly 100. As shown in FIG. 2, the forward wing segment tilt positions also comprise a plurality of forward wing segment pitched positions 254 that correspond to the plurality of pitched thrust configurations 154 of wing assembly 100. Forward wing segment 200 also may be referred to as forward wing assembly 200, forward tilt wing 200, leading wing segment 200, and/or forward wing portion 200.

As shown in FIGS. 1 and 2, in some examples, aircraft 10 further comprises one or more propulsion units 400 that are operatively coupled to airframe 20. When included, propulsion units 400 are configured to supply thrust to aircraft 10 when wing assembly 100 is in forward thrust configuration 152 and when wing assembly 100 is among pitched thrust configurations 154. Put differently, propulsion units 400 may be described as being configured to supply thrust to the aircraft when forward wing segment 200 is oriented in forward wing segment forward thrust position 252 and when forward wing segment 200 is among forward wing segment pitched positions 254. In some examples, one or more propulsion units 400 are operatively coupled to wing assembly 100. As a more specific example, aircraft 10 may comprise one or more propulsion units 400 that are operatively coupled to forward wing segment 200, as shown in FIGS. 1 and 2. In such examples, propulsion units 400 are configured to be tilted with forward wing segment 200 among the plurality of forward wing segment tilt positions and supply thrust to aircraft 10 along a plurality of thrust vectors that correspond to the plurality of forward wing segment tilt positions. Additionally or alternatively, propulsion units 400 may be operatively coupled to rear wing segment 300 and/or one or more additional rear wing segments 380 and may be tilted therewith, such as discussed in detail herein for examples in which propulsion units 400 are operatively coupled to forward wing segment 200.

Aircraft 10 includes any suitable number, type, and/or distribution of propulsion units 400 such that thrust supplied by propulsion units 400 is adequate and/or may be adequately controlled to maneuver aircraft 10 in any desirable manner. In some examples, propulsion units 400 are configured to supply adequate thrust to aircraft 10 to permit aircraft 10 to takeoff vertically. As more specific examples, aircraft 10 may include at least 2 propulsion units, at least 4 propulsion units, at least 6 propulsion units, at least 8 propulsion units, and/or at most 10 propulsion units.

As discussed herein, propulsion units 400 comprise any suitable propulsion system for supplying thrust to aircraft 10. As illustrated in FIG. 1, in some examples, one or more propulsion units 400 comprise a propulsion unit engine 410 that is configured to power thrust generation by the respective propulsion unit 400. In some examples, one or more propulsion units 400 comprise a powered rotor 402 that is configured to rotate and generate thrust responsive to power received by propulsion unit engine 410. Additionally or alternatively, propulsion units 400 include one or more jet engines 406, such as turbofan jet engines, that also may be powered by propulsion unit engines 410. With this in mind, propulsion unit engines 410 are powered by any suitable one or more power sources. As examples, propulsion unit engines 410 may be electrically powered, powered by liquid fuel (e.g. petroleum-based liquid fuel), and/or hybrid powered. Each propulsion unit engine 410 may be operatively interconnected with one or more power sources 60 included in aircraft 10 that are configured to supply power to propulsion unit engines 410.

When included, propulsion units 400 are coupled along any suitable region of airframe 20. As discussed herein, in some examples, propulsion units 400 are coupled along wing assembly 100. In some such examples, propulsion units 400 are operatively coupled along outboard portions 120 and/or inboard portion 122 of wing assembly 100, and outboard portions 120 and/or inboard portion 122 may be fixedly positioned within airframe 20. Additionally or alternatively, propulsion units 400 may be operatively coupled to one or more booms that extend within airframe 20 proximate wing assembly 100 and/or are operatively coupled to a fuselage 30 of aircraft 10. In any such examples, propulsion units 400 may be configured to be selectively and operatively tilted relative to longitudinal axis 22 of aircraft 10, such that propulsion units 400 may supply vectored thrust to aircraft 10 when wing assembly 100 is oriented in forward thrust configuration 152 and when wing assembly 100 is oriented among pitched thrust configurations 154. More generally, propulsion units 400 are configured to supply vectored thrust with any suitable pitch relative to longitudinal axis 22 of the aircraft, such as in the range from 0° and/or at most 95°.

When propulsion units 400 are operatively coupled to forward wing segment 200, propulsion units 400 may be coupled along any suitable region of forward wing segment 200. In some examples, propulsion units 400 are operatively coupled to forward wing segment 200 proximate leading edge regions 240 of forward wing segment 200. In some examples, propulsion units 400 extend from leading edge regions 240 of forward wing segment 200. Additionally or alternatively, propulsion units 400 may be operatively coupled along and/or extend from an upper surface and/or a lower surface of forward wing segment 200. In any of the above examples, propulsion units 400 may be positioned and/or configured to propel air rearwardly relative to each forward wing segment tilt position and provide vectored thrust to aircraft 10 in a reactive direction.

As schematically illustrated in FIG. 1, aircraft 10 may be described as having a longitudinal axis 22 that extends centrally through aircraft 10 in a positive direction from an aft region 14 of aircraft 10 through a nose region 16 of aircraft 10. In the present disclosure, a first structure may be referred to as a forward structure and/or as being forward of a second structure. In this context, the first structure may be located within aircraft 10, in a positive direction along longitudinal axis 22 from the second structure. Likewise, a third structure may be referred to as being a rear structure and/or as being rear of a fourth structure. In this context, the fourth structure may be located within aircraft 10, in a positive direction along longitudinal axis 22 from the third structure.

Additionally or alternatively, in the present disclosure, a particular structure may be referred to as having a left portion and/or a right portion. Likewise, a particular structure may be referred to as being a left structure or a right structure. In this context, the left structure or the left portion may be located within aircraft 10 left of longitudinal axis 22 when aircraft 10 is viewed from above, or illustrated in a top plan view, such as in FIG. 1. Similarly, the right structure or the right portion may be located within aircraft 10 to the right of longitudinal axis 22 when aircraft 10 is viewed from above, or illustrated in a top plan view.

In some of the examples discussed herein, one or more elements may be described in relation to one or more “respective” elements, such as a respective wing segment, and/or a respective propulsion unit. In such examples, the term “respective” may refer to a first element, and/or first set of elements that are discussed herein as being associated with, operatively coupled to, and/or otherwise interacting with a second element and/or a second set of elements.

With continued reference to FIGS. 1-2, in some examples, rear wing segment 300 is pivotally coupled within airframe 20 and is configured to be selectively tilted among a plurality of rear wing segment tilt positions. As illustrated in FIG. 1, in some examples, the plurality of rear wing segment tilt positions comprises a rear wing segment forward thrust position 352 that corresponds to forward thrust configuration 152 of wing assembly 100. As illustrated in FIG. 2, in some examples, the plurality of rear wing segment tilt positions comprises a plurality of rear wing segment pitched positions 354 that correspond to the plurality of pitched thrust configurations 154 of wing assembly 100.

In other examples, rear wing segment 300 is fixedly positioned within airframe 20 and is not configured to be tilted. In some such examples, rear wing segment 300 is fixedly positioned within the airframe in rear wing segment forward thrust position 352. Stated another way, in such examples, rear wing segment 300 is fixedly positioned within airframe 20 in rear wing segment forward thrust position 352 when wing assembly 100 is in forward thrust configuration 152 and when wing assembly 100 is in each pitched thrust configuration 154. Rear wing segment 300 also may be referred to as rear wing assembly 300, rear tilt wing 300, trailing wing segment 300, and/or rear wing portion 300.

As illustrated in FIG. 1, in some examples, aircraft 10 comprises a fuselage 30 to which wing assembly 100 is operatively coupled. In some examples, fuselage 30 comprises an internal volume that is configured to receive a payload, and optionally comprises one or more access doors that are configured to permit access to the internal volume of fuselage 30. Aircraft 10 further may comprise an empennage assembly 40, a landing gear assembly 42, and/or one or more flight control surfaces 180.

Aircraft 10 may take any suitable form including commercial aircraft, military aircraft, private aircraft, cargo aircraft, passenger aircraft, or any other suitable aircraft. Likewise, aircraft 10 may be a piloted aircraft, a semiautonomous aircraft, an autonomous aircraft, and/or a remote controlled aircraft.

In some examples, aircraft 10 is described as a vertical-take-off-and-landing (VTOL) aircraft. For example, aircraft 10 may be configured to be operated within an urban environment, and/or may be configured to take off and land with a runway of less than 10 meters. Additionally or alternatively, aircraft 10 is described as a tiltwing aircraft 10, as forward wing segment 200, and optionally rear wing segment 300 are configured to be selectively and operatively tilted among a plurality of tilt positions. More particularly, as discussed herein, forward wing segment 200 and rear wing segment 300 define discrete sections of wing assembly 100, and may be configured to be tilted independently of one another. With this in mind, wing assembly 100 may be described as having a split-wing configuration 102, and aircraft 10 may be described as a split-tiltwing aircraft. At least in this regard, aircraft 10 differ from conventional tiltwing aircraft, which generally include non-segmented wing assemblies that are tilted as a unit.

As shown in FIG. 1, in some examples, wing assembly 100 comprises one or more additional rear wing segments 380 that are positioned within wing assembly 100 rearwardly of rear wing segment 300. As examples, wing assembly 100 may include at least 1, at least 2, at least 3, at least 4, and/or at most 6 additional rear wing segments 380. When wing assembly 100 comprises more than one additional rear wing segment 380 each additional rear wing segment 380 may be positioned within wing assembly 100 rearwardly of a forwardly positioned additional rear wing segment 380. For example, when wing assembly 100 comprises a first additional rear wing segment 380 and a second additional rear wing segment 380, the first additional rear wing segment 380 is positioned rearwardly of rear wing segment 300 and the second additional rear wing segment 380 is positioned rearwardly of the first additional rear wing segment 380.

As discussed herein with respect to forward wing segment 200 and rear wing segment 300, when wing assembly 100 comprises additional rear wing segment(s) 380, additional wing segment(s) are configured to define continuous airfoil shape 130 along with forward wing segment 200 and rear wing segment 300 when wing assembly 100 is in forward thrust configuration 152. Similarly, when wing assembly 100 is among pitched thrust configurations 154, one or more additional rear wing segment(s) 380 may be configured to form discrete airfoil shapes.

As discussed herein with respect to rear wing segment 300, in some examples, one or more additional rear wing segments 380 are pivotally coupled within airframe 20. Additionally or alternatively, one or more additional rear wing segments 380 may be fixedly positioned within airframe 20. When any given additional rear wing segment 380 is pivotally coupled within the airframe, the additional rear wing segment 380 may be configured to be tilted among a plurality of additional rear wing segment tilt positions, including an additional rear wing segment forward thrust position 392 and a plurality of additional rear wing segment pitched positions 394.

With continued reference to FIGS. 1-2, in some examples, aircraft 10 comprises one or more tilt mechanisms 430 that are configured to selectively tilt forward wing segment 200 among the plurality of forward wing segment tilt positions. In some examples, tilt mechanisms 430 additionally are configured to selectively tilt rear wing segment 300 among the plurality of rear wing segment tilt positions. For some examples in which wing assembly 100 comprises additional rear wing segment(s) 380, tilt mechanism(s) 430 additionally are configured to selectively tilt at least one additional rear wing segment 380 among the plurality of additional rear wing segment tilt positions. As discussed herein, “tilting” any given wing segment may include pivoting the wing segment about its spanwise axis. However, in some examples, tilting the wing segment further may include a more complex motion in which the wing segment is moved vertically and/or laterally during the tilting.

In some examples, tilt mechanism(s) 430 are configured to operatively support and selectively retain forward wing segment 200 in each forward wing segment tilt position. As a more specific example, during operation of aircraft 10, tilt mechanisms 430 may be configured to operatively support and selectively retain forward wing segment 200 in forward wing segment forward thrust position 252 when aircraft 10 is in a cruising configuration, and may be configured to operatively support and selectively retain forward wing segment 200 among, and/or within each, forward wing segment pitched position 254 when aircraft 10 is in an ascent and/or a decent configuration. Similarly, tilt mechanism(s) 430 additionally may be configured to selectively retain rear wing segment 300, and/or additional rear wing segment(s) 380 among the respective tilt positions such as described herein with respect to forward wing segment 200. With this in mind, in some examples, aircraft 10 is configured to be operated as a fixed wing aircraft, such that tilt mechanisms 430 may be configured to operatively support and selectively retain forward wing segment 200, rear wing segment 300, and additional rear wing segment(s) 380 in the respective forward thrust positions at any suitable time during operation of aircraft 10, such as during takeoff, landing, climbing, descending, and/or cruising.

Tilt mechanisms 430 comprise any suitable mechanism for tilting forward wing segment 200, optionally rear wing segment 300, and optionally additional rear wing segment(s) 380 among the respective plurality of tilt positions. Examples of suitable tilt mechanisms 430 include hinged tilt mechanisms, rotatable tilt mechanisms, and/or jack tilt mechanisms. As discussed in more detail herein with reference to FIGS. 8-14, the particular tilt mechanism 430 may be selected based on a particular configuration of wing assembly 100. In some examples, each tilt mechanism 430 comprises one or more tilt mechanism actuators 450 that are configured to facilitate tilting of at least one respective wing segment. Examples of suitable tilt mechanism actuators 450 include mechanical tilt mechanism actuators, electromechanical tilt mechanism actuators, hydro-mechanical tilt mechanism actuators, screw jack tilt mechanism actuators, hydraulic jack tilt mechanism actuators, torqueing tilt mechanism actuators, and/or cogwheel tilt mechanism actuators. Tilt mechanism actuators 450 are powered in any suitable manner, such as pneumatically powered, electrically powered, hydraulically powered, and/or mechanically powered. With this in mind, each tilt mechanism actuator 450 may be interconnected with one or more power sources 60 included in aircraft 10 that are configured to supply power to tilt mechanism actuators 450.

As illustrated in FIG. 1, tilt mechanisms 430 may be operatively coupled to forward wing segment 200, optionally rear wing segment 300, and optionally additional rear wing segment(s) 380. Tilt mechanisms 430 may be positioned along or within any suitable region of aircraft 10. In some examples, one or more tilt mechanisms 430 are operatively coupled to fuselage 30 proximate to wing assembly 100. In some examples, one or more tilt mechanism 430 are positioned along or within wing assembly 100. Additionally or alternatively, as indicated in dot-dashed lines in FIG. 1, in some examples, a first portion of a particular tilt mechanism 430 is positioned along fuselage 30 and one or more second portions of the tilt mechanism 430 extend along or within regions of wing assembly 100. As a more specific example, a particular tilt mechanism 430 may include a first tilt mechanism actuator portion 450, one or more mechanical coupling elements, and a second tilt mechanism actuator portion 450. In some such examples, the first tilt mechanism actuator portion 450 is positioned along or within fuselage 30, the one or more mechanical coupling elements extend along or within wing assembly 100 from first tilt mechanism actuator portion 450 to a second tilt mechanism actuator portion 450 that is operatively coupled to a respective wing segment. In this way, actuation of the first tilt mechanism actuator portion 450 is transmitted through the one or more mechanical coupling elements to the second tilt mechanism actuator portion to facilitate tilting of the respective wing segment.

As schematically shown in FIGS. 1-2, in some examples, aircraft 10 comprises a forward wing segment tilt mechanism 432 that is configured to selectively tilt forward wing segment 200 among the plurality of forward wing segment tilt positions. In some such examples, aircraft 10 additionally comprises a rear wing segment tilt mechanism 434 that is configured to selectively tilt rear wing segment 300 among the plurality of rear wing segment tilt positions. Likewise, when aircraft 10 comprises one or more additional rear wing segments 380, aircraft 10 may comprise a separate tilt mechanism 430 for tilting each additional rear wing segment 380.

In some examples, tilt mechanisms 430 are configured to tilt forward wing segment 200, rear wing segment 300, and optionally additional rear wing segment(s) 380 in unison, such that each forward wing segment tilt position corresponds to each rear wing tilt position, and optionally corresponds to each additional rear wing segment tilt position. In other examples, tilt mechanisms 430 are configured to tilt forward wing segment 200, rear wing segment 300, and optionally additional rear wing segment(s) 380, independently, such that forward wing segment 200, rear wing segment 300, and optionally additional rear wing segment(s) 380 each may be tilted at a different pitched angle. For a more specific example in which tilt mechanisms 430 are configured to tilt each wing segment independently, tilt mechanisms 430 may be configured to tilt forward wing segment 200 among forward wing segment pitched positions 254 while operatively retaining rear wing segment 300 in rear wing segment forward thrust position 352.

With continued reference to FIGS. 1-2, forward wing segment 200, rear wing segment 300, and optionally additional rear wing segment(s) 380 may span any suitable portion of wing assembly 100. In some examples, forward wing segment 200, rear wing segment 300, and/or additional rear wing segment(s) 380 span an entire wingspan of wing assembly 100. Additionally or alternatively, forward wing segment 200, rear wing segment 300, and/or additional rear wing segments 380 define spanwise portions of wing assembly 100.

As shown in FIGS. 1-2, in some examples, forward wing segment 200, rear wing segment 300, and/or additional rear wing segment(s) 380 span a centerline 24 of aircraft 10. In some examples, forward wing segment 200 comprises a forward left wing segment 220 and a forward right wing segment 222, in which forward left wing segment 220 and forward right wing segment 222 may extend in opposing outboard directions from centerline 24. Likewise, in some examples, rear wing segment 300 comprises a rear left wing segment 320 and a rear right wing segment 322, in which rear left wing segment 320 and rear right wing segment 322 may extend in opposing outboard directions from centerline 24. As discussed in more detail herein, in some examples, forward left wing segment 220 and forward right wing segment 222 are configured to be independently tilted among the plurality of forward wing segment tilt positions, which, in some examples may be performed to control a yawing moment in the aircraft. Likewise, in some examples, rear left wing segment 320 and rear right wing segment 322 are configured to be independently tilted among the plurality of rear wing segment tilt positions, which, in some examples may be performed to control a yawing moment in the aircraft. Additionally or alternatively, forward left wing segment 220 and forward right wing segment 222 are configured to be tilted as a unit and/or rear left wing segment 320 and rear right wing segment 322 are configured to be tilted as a unit.

In some examples, wing assembly 100 comprises an inboard portion 122 that spans centerline 24 and is positioned within wing assembly 100 inboard of forward wing segment 200, rear wing segment 300, and/or additional rear wing segment(s) 380. More specifically, in some examples, inboard portion 122 is positioned within wing assembly 100 inboard of (i.e., between) forward right wing segment 222 and forward left wing segment 220. Similarly, in some examples, inboard portion 122 is positioned inboard of (i.e., between) rear left wing segment 320 and rear right wing segment 322 of rear wing segment 300. In some examples, inboard portion 122 is fixedly positioned within airframe 20, and forward wing segment 200, and optionally rear wing segment 300 and/or additional rear wing segment(s) 380, are pivotally coupled to inboard portion 122. Additionally or alternatively, rear wing segment 300 and/or additional rear wing segment(s) 380 may be fixedly coupled to inboard portion 122.

As further shown in FIGS. 1-2, in some examples, wing assembly 100 comprises outboard portions 120 that are positioned within wing assembly 100 outboard of forward wing segment 200, rear wing segment 300, and/or additional rear wing segment(s) 380. In some examples, outboard portions 120 are fixedly positioned within airframe 20. In some such examples, forward wing segment 200, and optionally rear wing segment 300 and/or additional rear wing segment(s) 380, are pivotally coupled to outboard portions 120. Additionally or alternatively, rear wing segment 300 and/or additional rear wing segment(s) 380 are fixedly coupled to outboard portions 120.

Forward wing segment 200, rear wing segment 300, and optionally additional rear wing segment(s) 380 possess any suitable dimension relative to one another. In some examples, forward wing segment 200, rear wing segment 300, and additional rear wing segment(s) 380 are configured to comprise substantially similar chord lengths and/or wingspans. In other examples, forward wing segment 200, rear wing segment 300, and/or additional rear wing segment(s) 380 are configured to comprise different chord lengths and/or wingspans. In some examples, the chord length and/or wingspan of each wing segment is selected such that each wing segment possess a desired aspect ratio for providing lift and maneuverability to aircraft 10 when wing assembly 100 is oriented among pitched thrust configurations 154. Additionally or alternatively, the chord length and/or wingspan of each wing segment is selected such that wing assembly 100 and/or continuous airfoil shape 130 comprises a desired aspect ratio when wing assembly 100 is oriented in forward thrust configuration 152.

Similarly, forward wing segment 200, rear wing segment 300, and additional rear wing segment(s) 380 (when included) are positioned along any region of wing assembly 100 relative to one another. In some examples, forward wing segment 200, rear wing segment 300, and additional rear wing segment(s) 380 occupy substantially similar and longitudinally aligned spanwise portions of wing assembly 100. In other examples, forward wing segment 200, rear wing segment 300 and/or additional rear wing segment(s) 380 occupy different spanwise portions of wing assembly 100. As an example, for some examples in which propulsion units 400 are operatively coupled to forward wing segment 200 and rear wing segment 300 is pivotally coupled within airframe 20, rear wing segment 300 is centered rearwardly of propulsion units 400 and defines a narrower spanwise portion of wing assembly 100 relative to forward wing segment 200, such that a passage volume is created between forward wing segment 200 and rear wing segment 300 for directing slipstreams generated by propulsion units 400 when forward wing segment 200 and rear wing segment 300 are tilted among their respective tilt positions.

As discussed herein, in some examples, forward wing segment 200, rear wing segment 300, and/or one or more additional rear wing segment(s) 380 are configured to form discrete airfoil shapes when wing assembly 100 is oriented among pitched thrust configurations 154. As shown in FIG. 1, in some examples, wing assembly 100 comprises one or more transition panels 140 that are configured to form one or more smooth transition surfaces between forward wing segment 200 and rear wing segment 300 when wing assembly 100 is oriented in forward thrust configuration 152. Additionally or alternatively, in some examples, transition panel(s) 140 are configured to form one or more smooth transition surfaces between rear wing segment 300 and additional rear wing segment(s) 380, and/or between one or more additional rear wing segments 380, when wing assembly 100 is oriented in forward thrust configuration 152. Stated in more general terms, in some examples, transition panels 140 are configured to smooth the discrete shapes defined by forward wing segment 200, rear wing segment 300, and/or one or more additional rear wing segments 380 into continuous airfoil shape 130 when wing assembly 100 is oriented in forward thrust configuration 154.

With continued reference to FIGS. 1-2, in some examples, aircraft 10 comprises one or more flight control surfaces 180. When included, aircraft 10 comprises any suitable one or more types of flight control surface(s) 180, and flight control surface(s) 180 are positioned along any suitable region of wing assembly 100 and/or empennage assembly 40. Examples of suitable flight control surfaces 180 include flaps, leading edge flaps, ailerons, elevators, spoilers, slats, leading edge slats, and/or rudders. In some examples, each flight control surface 180 comprises one or more flight control surface actuators 184 that are configured to selectively and operatively adjust the flight control surface 180. As shown, when wing assembly 100 comprises inboard portion 122, at least a portion of one or more flight control surfaces 180 may be positioned along and/or extend from inboard portion 122. Similarly, when wing assembly 100 comprises outboard portions 120, at least a portion of one or more flight control surfaces 180 may be positioned along and/or extend from outboard portions 120. When included, flight control surfaces 180 additionally or alternatively define and/or extend from any suitable region of forward wing segment 200, rear wing segment 300, and/or additional rear wing segment(s) 380. In some examples, forward wing segment 200 comprises one or more leading edge flaps and/or leading edge slats that are positioned along leading edge regions 240 of forward wing segment 200. In some examples, rear wing segment 300 comprises ailerons 182 that are positioned along and/or extend from trailing edge regions 330 of rear wing segment 300. Additionally or alternatively, when wing assembly 100 comprises additional rear wing segment(s) 380 that are positioned within wing assembly 100 rearwardly of rear wing segment 300, trailing edge regions of a rearward-most additional rear wing segment 380 may be supplied with ailerons 182.

That said, in some examples, aircraft 10 is configured to be operated without utilizing and/or needing conventional flaps. More specifically, in some examples, operative tilting of forward wing segment 200, rear wing segment 300, and/or additional rear wing segment(s) 380 during operation of aircraft 10 provides sufficient control over wing lift, such that conventional flaps are not needed to maneuver aircraft 10. As a more specific example, to provide lift control within wing assembly 100 while wing assembly 100 is oriented in forward thrust configuration 152, rear wing segment 300, and/or additional rear wing segments 380 may be configured to be tilted within a narrow range to control wing lift while still forming continuous airfoil shape 130 with forward wing segment 200.

Turning now to FIGS. 3-7, illustrated therein are schematic representations showing examples of wing assembly 100 in forward thrust configuration 152 and among pitched thrust configurations 154. FIGS. 3-7 illustrate example wing assemblies 100 that may be included and/or utilized in aircraft 10. The examples of FIGS. 3-7 are illustrative, non-exclusive examples and the components, features, and/or orientations illustrated in each of the examples of FIGS. 3-7 may be combined with, included in, and/or utilized in any other example of FIGS. 3-7 and/or aircraft 10 in any suitable manner without departing from the scope of the present disclosure.

With initial reference to FIG. 3, illustrated are examples of wing assembly 100 oriented in forward thrust configuration 152, in which trailing edge region 230 of forward wing segment 200 is substantially aligned with leading edge region 340 of rear wing segment 300. More specifically, in the example shown, forward wing segment 200 is tilted in forward wing segment forward thrust position 252 and rear wing segment 300 is tilted in rear wing segment forward thrust position 352 such that wing assembly 100 defines continuous airfoil shape 130. While FIG. 3 illustrates forward wing segment 200 abutting rear wing segment 300, forward wing segment 200 and rear wing segment 300 are not required to be physically engaging and/or touching while wing assembly 100 is oriented in forward thrust configuration 152 in all examples of the present disclosure.

In some of the examples represented in FIG. 3, wing assembly 100 comprises one or more transition panels 140 that are configured to form smooth transition surfaces 146 between forward wing segment 200 and rear wing segment 300 to define continuous airfoil shape 130. More specifically, in some examples, wing assembly 100 comprises an upper transition panel 142 that is configured to form smooth transition surface 146 between an upper surface 210 of forward wing segment 200 and an upper surface 310 of rear wing segment 300. In some examples, wing assembly 100 comprises a lower transition panel 144 that is configured to form smooth transition surface 146 between a lower surface 212 of forward wing segment 200 and a lower surface 312 of rear wing segment 300. As shown, in some examples, transition panels 140 extend from a trailing half 232 of forward wing segment 200 to contact a leading half 342 of rear wing segment 300.

When included, transition panels 140 are operatively coupled to forward wing segment 200 and/or rear wing segment 300 in any suitable manner. In some examples, one or more transition panels 140 are hingedly coupled to forward wing segment 200 by a hinge mechanism, and transition panels 140 are configured to extend rearwardly from the hinge mechanism to operatively contact and/or rest upon a surface of rear wing segment 300. In some such examples, the hinge mechanisms are biased and configured to urge the one or more transition panels into operative contact with rear wing segment 300. Additionally or alternatively, in some examples, transition panels 140 are extendably coupled to forward wing segment 200. More specifically, in some examples, transition panels 140 are configured to be selectively and operatively retracted from operative contact with rear wing segment 300 when wing assembly 100 is selectively transitioned from forward thrust configuration 152 (as in FIG. 3) to among pitched thrust configurations 154 (as in FIG. 4). Similarly, in some examples, transition panels 140 are configured to be selectively and operatively extended from forward wing segment 200 to operatively contact rear wing segment 300 when wing assembly 100 is selectively transitioned to forward thrust configuration 152 (as in FIG. 3) from among pitched thrust configurations 154 (as in FIG. 4).

FIG. 4 illustrates examples of wing assembly 100 having been transitioned from forward thrust configuration 152 shown in FIG. 3 to among pitched thrust configurations 154. In FIG. 4, forward wing segment 200 is tilted among forward wing segment pitched positions 254, and rear wing segment 300 is tilted among rear wing segment pitched positions 354. More specifically, forward wing segment pitched position 254 corresponds to rear wing segment pitched position 354 with forward wing segment 200 and rear wing segment 300 being generally aligned. Forward wing segment 200 defines forward wing segment airfoil 202 and rear wing segment 300 defines rear wing segment airfoil 302. As shown in dashed lines, transition panels 140 optionally are operatively attached to forward wing segment 200 and are configured to adopt a flush fit with upper surface 210 and/or lower surface 212 of forward wing segment 200. Stated another way, transition panels 140 are configured to fit flush with the airfoil shape defined by forward wing segment airfoil 202. Additionally or alternatively, in some examples, transition panels 140 are configured to extend rearwardly beyond forward wing segment 200 to define a trailing edge of forward wing segment 200 when forward wing segment 200 is oriented among forward wing segment pitched positions 254.

Generally speaking, the amount of lift that can be generated across any given airfoil is at least partially determined by the airflow characteristics across upper and lower surfaces of the airfoil, and the airflow characteristics in turn may be influenced by an angle of attack of the airfoil. During flight, it is important that airflow remains attached to the upper surface of an airfoil such that adequate lift is generated in the airfoil and wing stall is avoided. As airfoils tend to be more susceptible to airflow separation at higher angles of attack, traditional tiltwing aircraft often are compromised by wing stall when the wings are transitioned between cruising and vertical thrust orientations.

As shown in the examples of FIG. 4, when wing assembly 100 is oriented in pitched thrust configuration 154, forward wing segment 200 and rear wing segment 300 are spaced apart and define a passage volume 170 therebetween. In contrast to traditional tiltwing aircraft that include non-segmented tilt wings, the passage volume 170 defined by forward wing segment 200 and rear wing segment 300 may direct airflow 174 across upper surface 210 of forward wing segment 200, such as to prevent airflow separation from forward wing segment 200 and/or prevent wing stall when wing assembly 100 is transitioned among forward thrust configuration 152 and pitched thrust configurations 154. With this in mind, in some examples, passage volume 170 is configured to benefit a maximum lift coefficient of wing assembly 100 and/or of forward wing segment 200.

Additionally or alternatively, in some examples, one or more propulsion units are operatively oriented within the airframe to direct slipstreams within the passage volume 170, and passage volume 170 is configured to direct the slipstreams generated by the propulsion units. More specifically, in some such examples, passage volume 170 is configured to provide a duct augmentation effect by having the propwash or propeller slipstream flow inside the “channel” formed by forward wing segment 200 and rear wing segment 300. More specifically, passage volume 170 may restrict the contraction that the slipstreams would experience in free flow. The duct augmentation effect is a well-established phenomenon by which, within bounds, the thrust of an appropriately ducted propeller or fan is higher than what the same propeller or fan would produce without the duct. For an ideal case, a propeller imparts an increment of velocity to the flow that passes through its actuation disk. That flow continues to accelerate until it reaches a velocity that is twice the value imparted at the propeller disk. Because the air behaves in an incompressible manner, at the same time that the air velocity increases, its cross sectional area decreases (i.e., the slipstream contracts). In a duct, because no vacuum can form between the slipstream and the wall, the flow cannot contract and instead the pressure is increased, hence increasing the equivalent thrust.

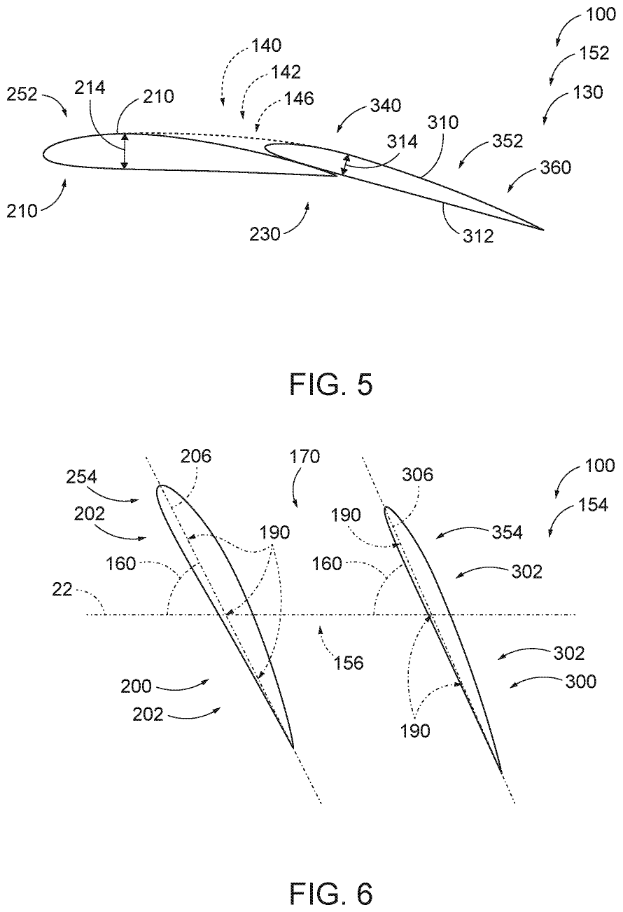

FIG. 5 illustrates more examples of wing assembly 100 oriented in forward thrust configuration 152. As shown, in some examples, forward wing segment 200 and rear wing segment 300 are configured to overlap in forward thrust configuration 152. More specifically, in the example shown, upper surface 210 of trailing edge region 230 of forward wing segment 200 overlaps with lower surface 312 of leading edge region 340 of rear wing segment 300. In some examples, overlapping forward wing segment 200 and rear wing segment 300 in forward thrust configuration 152 provides a smooth transition surface 146 across a lower surface of wing assembly 100, which may be beneficial to forming a smooth continuous airfoil shape 130. As shown, in such a configuration, wing assembly 100 optionally comprises upper transition panel 142 that is configured to form smooth transition surface 146 across upper surface 210 of forward wing segment 200 and upper surface 310 of rear wing segment 300.

With continued reference to FIG. 5, a maximum thickness 214 of forward wing segment 200 and a maximum thickness 314 of rear wing segment 300 at a given cross section of wing assembly 100 may be independently selected, such as to provide wing assembly 100 with a desired continuous airfoil shape 130 in forward thrust configuration 152 and/or to provide forward wing segment 200 and rear wing segment 300 with desired airfoil shapes when wing assembly 100 is among pitched thrust configurations 154. With this in mind, thickness 214 of forward wing segment 200 and thickness 314 of rear wing segment 300 may be selected to possess any suitable magnitude relative to one another. As illustrated in FIG. 5, in some examples, thickness 214 of forward wing segment 200 is selected to be greater than thickness 314 of rear wing segment 300, such that continuous airfoil shape 130 is relatively smooth and/or generally tapered rearwardly.

FIG. 6 illustrates examples of wing assembly 100 tilted from forward thrust configuration 152 of FIG. 5 to among pitched thrust configurations 154. As shown in these examples, forward wing segment 200 is oriented among forward wing segment pitched positions 254 with a chord 206 of forward wing segment 200 being tilted to a pitched angle 160 relative to longitudinal axis 22 of aircraft 10. Similarly, rear wing segment 300 is oriented among rear wing segment pitched positions 354 with a chord 306 of rear wing segment 300 being tilted to a pitched angle 160 relative to a longitudinal axis 22 of aircraft 10.

In some examples, each forward wing segment tilt position comprises a corresponding pitched angle 160. Similarly, in some examples, each rear wing segment tilt position comprises corresponding pitched angle 160. Stated another way, forward wing segment 200 and rear wing segment 300 each may be configured to be tilted among a plurality of pitched angles 160. The forward wing segment tilt positions and the rear wing segment tilt positions comprise any suitable range of pitched angles 160, for example, from 0° to a maximum of 95°.

Forward wing segment 200 and rear wing segment 300 may be oriented with any pitched angle 160 relative to one another during operation of aircraft 10. In some examples, forward wing segment 200 and rear wing segment 300 are tilted in unison by the tilt mechanism(s) such that each forward wing segment tilt position corresponds to each rear wing segment tilt position, such that forward wing segment 200 and rear wing segment 300 are oriented with substantially similar pitched angles 160, and/or such that chord 206 of forward wing segment 200 is substantially aligned with chord 306 of rear wing segment 300. Additionally or alternatively, in some examples, forward wing segment 200 and rear wing segment 300 are tilted independent by the tilt mechanism(s) and may be oriented with different pitched angles 160. As shown in FIG. 6, in some examples, the respective pitched angles 160 of forward wing segment 200 and rear wing segment 300 are operatively controlled to vary the geometry of passage volume 170, which may operatively result in selective control over airflow across forward wing segment 200 and/or directing of the slipstreams from the propulsion units.

With continued reference to FIG. 6, in some examples, forward wing segment 200 is configured to be tilted about a pivot point 190 that is positioned at any suitable location about the thickness and/or chord 206 of forward wing segment 200. Likewise, in some examples, rear wing segment 300 is configured to be tilted about pivot point 190 that is positioned at any suitable location about the thickness and/or chord 306 of rear wing segment 300. In some examples, forward wing segment 200 and rear wing segment 300 are configured to possess the same, or substantially similar pivot points 190, and in other examples, forward wing segment 200 and rear wing segment 300 are configured to possess different pivot points 190.

As further shown in FIG. 6, when wing assembly 100 is oriented among pitched thrust configurations 154, forward wing segment 200 and rear wing segment 300 are spaced apart by separation 156. In some examples, separation 156 extends along longitudinal axis 22 of the aircraft. The magnitude of separation 156 may be selected on the basis of the position of forward wing segment 200 and rear wing segment 300 relative to one another within wing assembly 100, the respective pivot points 190 of forward wing segment 200 and rear wing segment 300, and/or the respective pitched angles 160 of forward wing segment 200 and rear wing segment 300. With this in mind, in some examples, separation 156 is selectively varied as wing assembly 100 is selectively transitioned among pitched thrust configurations 154. It is within the scope of the present disclosure that wing assembly 100 may be configured to possess any suitable separation 156 at any given pitched thrust configuration 154, when forward wing segment 200 is tilted to any given forward wing segment pitched position 254, and/or when rear wing segment 300 is tilted to any given rear wing segment pitched position 354. In some examples, separation 156 is defined as a threshold fraction of the length of forward wing segment chord 206 at a respective location corresponding to separation 156. As examples, within any given pitched thrust configuration 154, separation 156 may be at least 5%, at least 10%, at least 20%, at least 40%, at least 60%, at least 80%, at least 100%, at least 120%, at most 150%, and/or at most 200% the length of forward wing segment chord 206.

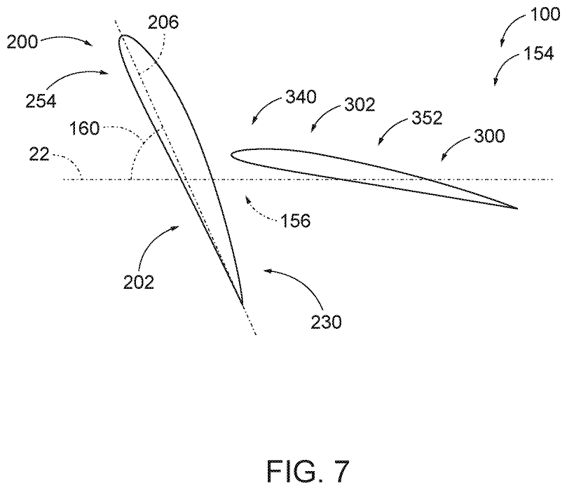

FIG. 7 illustrates another example of the wing assembly 100 of FIG. 5 transitioned to among pitched thrust configurations 154. In this example, forward wing segment 200 is tilted among forward wing segment pitched positions 254, while rear wing segment 300 is in rear wing segment forward thrust position 352. Stated another way, FIG. 7 illustrates an example in which forward wing segment 200 is oriented with a different pitched angle 160 relative to rear wing segment 300. As shown, forward wing segment 200 defines forward wing segment airfoil 202, and rear wing segment 300 defines rear wing segment airfoil 302. In this configuration, forward wing segment 200 and rear wing segment 300 are spaced apart by separation 156, such as to provide a channel for slipstreams generated by the propulsion units.

While FIG. 7 illustrates an example in which forward wing segment 200 is tilted among forward wing segment pitched positions 254 and rear wing segment 300 is in rear wing segment forward thrust position 352, in other examples, rear wing segment 300 may be tilted among rear wing segment pitched positions 354 while forward wing segment 200 is selectively and operatively retained in forward wing segment forward thrust position 252. In some such examples, forward wing segment 200 is pivotally coupled within airframe 20 and is selectively and operatively retained in forward wing segment forward thrust position 252 by the one or more tilt mechanisms. In other such examples, forward wing segment 200 is fixedly positioned within airframe 20 and rear wing segment 300 is pivotally coupled within airframe 20 and configured to be tilted by the tilt mechanisms. In any such examples, the propulsion unit may be operatively coupled to rear wing segment 300 and may be tilted with rear wing segment 300 among the rear wing segment tilt positions.

While the illustrations of FIGS. 3-7 focus on example features, functions, and the relative orientations of forward wing segment 200 and rear wing segment 300, it is within the scope of the present disclosure that the features, functions, and relative orientations discussed herein with reference to FIGS. 3-7 equally apply to examples in which wing assembly 100 further comprises one or more additional rear wing segment(s). More specifically, the discussion herein with reference to FIGS. 3-7 similarly may be applied to any two adjacent wing segments, such as rear wing segment 300 and an adjacent additional rear wing segment 380 and/or two adjacent additional rear wing segments 380.

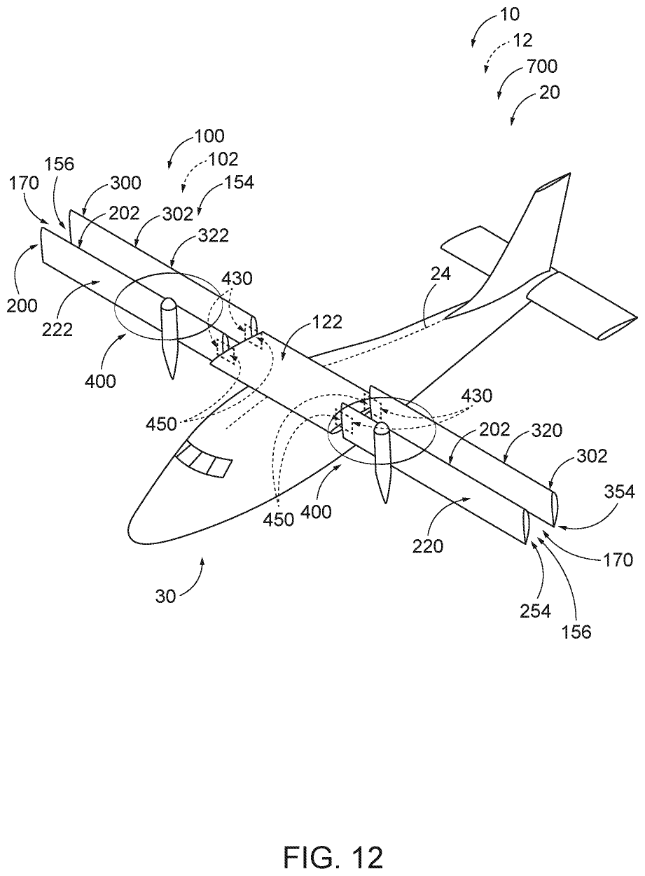

FIGS. 8-14 illustrate less schematic examples of aircraft 10 indicated at and referred to herein as aircraft 600 (FIGS. 8-10), aircraft 700 (FIGS. 11-12), and aircraft 800 (FIGS. 13-14). In general, aircraft 600, aircraft 700, and aircraft 800 illustrate examples of aircraft 10 in which aircraft 10 is a tiltwing aircraft 12 having wing assembly 100 with split-wing configuration 102.

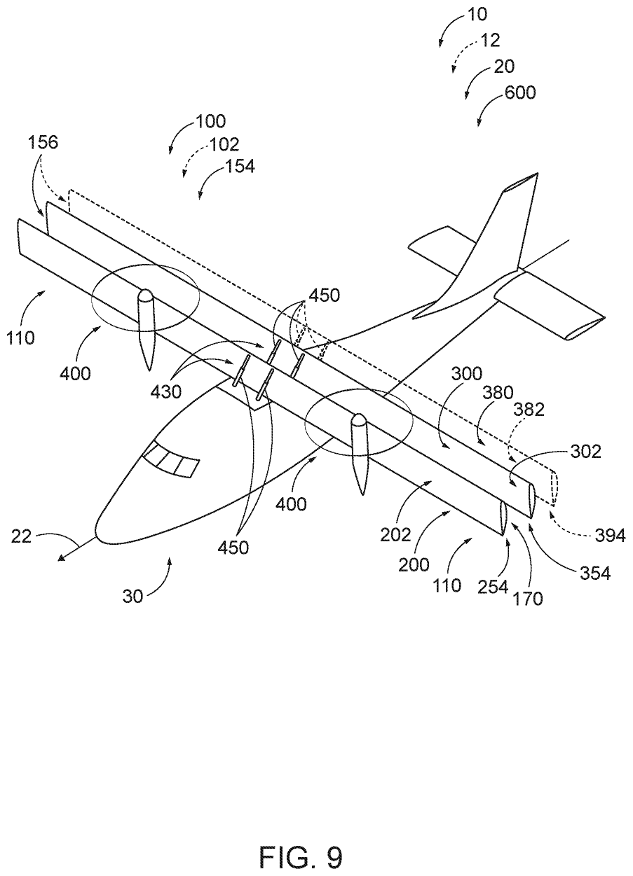

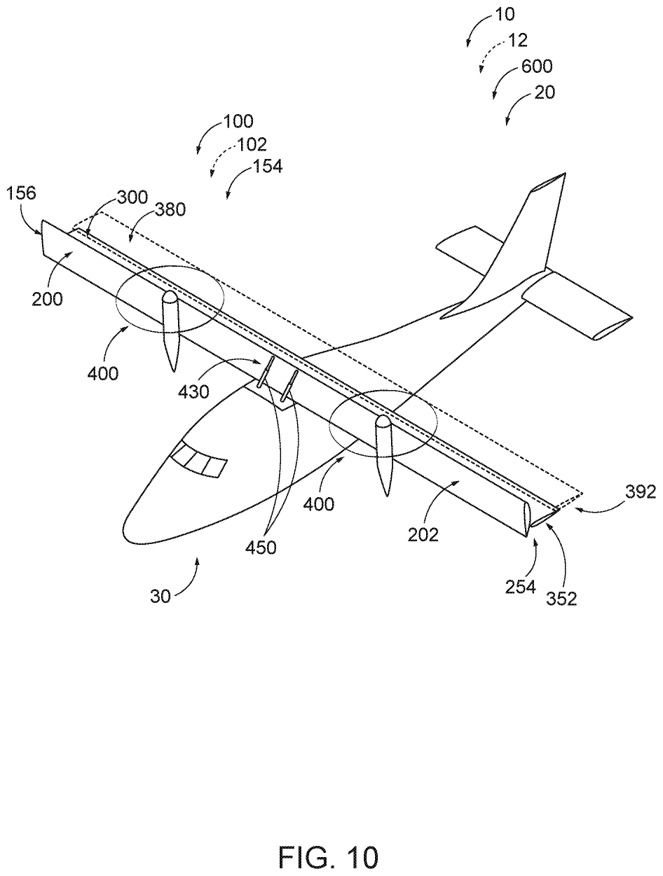

With initial reference to FIGS. 8-10, illustrated therein are examples of aircraft 600, in which FIG. 8 illustrates examples of aircraft 600 with wing assembly 100 oriented in forward thrust configuration 152, and FIGS. 9-10 illustrate examples of aircraft 600 with wing assembly 100 oriented among pitched thrust configurations 154. As shown in FIG. 8, wing assembly 100 of aircraft 600 comprises forward wing segment 200, rear wing segment 300, and optionally additional rear wing segment 380 with forward wing segment 200 being positioned forward of rear wing segment 300, and rear wing segment 300 being positioned forward of an optional additional rear wing segment 380. In forward thrust configuration 152, forward wing segment 200 is tilted in forward wing segment forward thrust position 252, rear wing segment 300 is tilted in rear wing segment forward thrust position 352, and additional rear wing segment 380 is tilted in additional rear wing segment forward thrust position 392 with forward wing segment 200, rear wing segment 300, and additional rear wing segment 380 forming continuous airfoil shape 130.

Aircraft 600 is illustrated in FIGS. 8-10 as optionally comprising a single additional rear wing segment 380; however, it is within the scope of the present disclosure that aircraft 600 may comprise two or more additional rear wing segments 380, and the discussion herein of optional additional rear wing segment 380 with reference to FIGS. 8-10 equally may apply to a wing assembly 100 having a plurality of additional rear wing segments 380 and/or to each additional rear wing segment 380 in a wing assembly 100 comprising a plurality of additional rear wing segments 380.

In the examples of FIG. 8, forward wing segment 200, rear wing segment 300, and optional additional rear wing segment 380 are operatively coupled to fuselage 30 and span centerline 24 of aircraft 600. Aircraft 600 comprises one or more tilt mechanisms 430 disposed along fuselage 30 proximate wing assembly 100 that are configured to operatively tilt forward wing segment 200, and optionally rear wing segment 300 and/or additional rear wing segment(s) 380. Aircraft 600 additionally comprises propulsion units 400 that are operatively coupled to forward wing segment 200 and generally aligned with a chord of continuous airfoil shape 130. Wing assembly 100 optionally comprises one or more flight control surfaces 180, such as ailerons 182 that are disposed along rear wing segment 300 and/or additional rear wing segment 380.

FIG. 9 illustrates examples of aircraft 600 with wing assembly 100 oriented among pitched thrust configurations 154. As shown, forward wing segment 200 is tilted among forward wing segment pitched positions 254, rear wing segment 300 is tilted among rear wing segment pitched positions 354, and additional rear wing segment(s) 380 are tilted among additional rear wing segment pitched positions 394. Tilt mechanisms 430 comprise one or more tilt mechanism actuators 450 for selectively tilting each wing segment. In the specific example of FIG. 9, each tilt mechanism actuator 450 comprises one or more screw jack tilt mechanism actuators that is operatively coupled to fuselage 30 and a respective wing segment.

In the examples shown, forward wing segment 200 defines forward wing segment airfoil 202, rear wing segment 300 defines rear wing segment airfoil 302, and additional rear wing segment 380 defines additional rear wing segment airfoil 382. Owing to split-wing configuration 102, each wing segment is spaced apart by separation 156 with a corresponding passage volume 170 being defined therebetween. Propulsion units 400 are tilted with forward wing segment 200 such that propulsion units 400 may provide pitched thrust to aircraft 600 in a thrust vector 420 that corresponds to the pitched angle of forward wing segment 200, such as vertical thrust for vertical flight.

As further shown, propulsion units 400 are oriented such that slipstreams generated by propulsion units 400 are directed through passage volume 170. In addition to providing the benefits discussed herein with respect to FIG. 4, passage volume 170 restricts wing assembly 100 from interfering with the slipstreams generated by propulsion units 400, which benefits the thrust efficiency of propulsion units 400. This feature of split-wing configuration 102 avoids the issue in many conventional tiltrotor aircraft of supporting wings interfering with slipstreams generated by tilted propulsion units and hampering thrust efficiency.

As further shown, wing assembly 100 defines a frontal area 110 when oriented among pitched thrust configurations 154. Frontal area 110 may be defined as the projected area of wing assembly 100 perpendicular to longitudinal axis 22. More specifically, frontal area 110 of wing assembly 100 includes the frontal area of forward wing segment 200 and may include a portion of the frontal area of rear wing segment 300 and/or a portion of the frontal area of additional rear wing segments 380. With this in mind, frontal area 110 of wing assembly 100 may vary with respect to the pitched position of one or more wing segments.

At any given pitched thrust configuration 154, wing assembly 100 defines a frontal area 110 that is smaller than a sum of the frontal areas defined by its respective wing segments. Stated another way, as rear wing segment 300 and optional additional rear wing segment 380 are positioned rearwardly of forward wing segment 200, at least a portion of the frontal area of rear wing segment 300 and at least a portion of the frontal area of additional rear wing segment 380 are eclipsed by forward wing segment 200 when wing assembly 100 is oriented among pitched thrust configurations 154. Thus, owing to split-wing configuration 102, wing assembly 100 defines a relatively small frontal area compared to the tilt wings of conventional tiltwing aircraft, in which the frontal area of the tilt wing is a projection of the total wing area.

Generally speaking, the tilt wings of conventional tiltwing aircraft define a large frontal area compared to fixed wing aircraft and/or tilt rotor aircraft when the tilt wings are pitched and/or oriented for vertical flight, and this large frontal area can render conventional tiltwing aircraft vulnerable to crosswinds and gusts when the tilt wings are pitched and/or oriented for vertical flight. With this in mind, the relatively small frontal area of wing assembly 100 that is afforded by split-wing configuration 102 may promote high control authority over aircraft 10 during vertical flight and/or in the presence of gusts and/or crosswinds.

FIG. 10 illustrates additional or alternative examples of aircraft 600 with wing assembly 100 oriented among pitched thrust configurations 154. In these examples, forward wing segment 200 is tilted among forward wing segment pitched positions 254, while rear wing segment 300 is in rear wing segment forward thrust position 352 and optional additional rear wing segment 380 is in additional rear wing segment forward thrust position 392. In some examples of aircraft 600, rear wing segment 300 and/or optional additional rear wing segment 380 are fixedly coupled within airframe 20 in the respective forward thrust positions. Additionally or alternatively, rear wing segment 300 and/or optional additional rear wing segment 380 are pivotally coupled within airframe 20 and are operatively supported and selectively retained in the respective forward thrust positions by tilt mechanisms 430.

As shown in FIG. 10, forward wing segment 200 defines forward wing segment airfoil 202 and is spaced apart from rear wing segment 300 by separation 156. Propulsion units 400 are tilted with forward wing segment 200 such as to supply pitched thrust to aircraft 600 and such that slipstreams generated by propulsion units are directed within separation 156, such as to prevent interference of wing assembly 100 with the slipstreams.

FIGS. 11-12 illustrate examples of aircraft 10 indicated at and referred to herein as aircraft 700, in which FIG. 11 illustrates examples of aircraft 700 with wing assembly 100 oriented in forward thrust configuration 152 and FIG. 12 illustrates examples of aircraft 700 with wing assembly 100 oriented among pitched thrust configurations 154. As shown in FIG. 11, wing assembly 100 comprises an inboard portion 122 that is coupled to fuselage 30. Wing assembly 100 also comprises forward wing segment 200 and rear wing segment 300 that are positioned within wing assembly 100 outboard of inboard portion 122. More specifically, forward wing segment 200 comprises forward left wing segment 220 and forward right wing segment 222 with inboard portion 122 being positioned within wing assembly 100 inboard of forward right wing segment 222 and forward left wing segment 220. Similarly, rear wing segment 300 comprises rear left wing segment 320 and rear right wing segment 322 with inboard portion 122 being positioned inboard of rear left wing segment 320 and rear right wing segment 322. In FIG. 11, forward wing segment 200 is tilted in forward wing segment forward thrust position 252 and rear wing segment 300 is tilted in rear wing segment forward thrust position 352, with forward wing segment 200, rear wing segment 300 and inboard portion 122 defining continuous airfoil shape 130.

In the examples of FIG. 11, inboard portion 122 is fixedly positioned within airframe 20 and forward wing segment 200 and optionally rear wing segment 300 are configured to pivot relative to inboard portion 122. In some examples, forward left wing segment 220 and forward right wing segment 222 are pivotally coupled to inboard portion 122. Additionally or alternatively, in some examples, forward left wing segment 220 and forward right wing segment 222 are operatively coupled to tilt mechanisms 430 that are configured to selectively and operatively tilt forward left wing segment 220 and forward right wing segment 222 among the plurality of forward wing segment tilt positions. In some examples, tilt mechanisms 430 are configured to tilt forward left wing segment 220 and forward right wing segment in unison, and in some examples, tilt mechanisms 430 are configured to tilt forward left wing segment 220 and forward right wing segment independently of one another.

Similarly, in some examples, rear left wing segment 320 and rear right wing segment 322 are pivotally coupled to inboard portion 122. Additionally or alternatively, in some examples, rear left wing segment 320 and rear right wing segment 322 are operatively coupled to tilt mechanisms 430 that are configured to selectively and operatively tilt rear left wing segment 320 and rear right wing segment 322 among the plurality of rear wing segment tilt positions. Tilt mechanism 430 may be configured to tilt rear left wing segment 320 and rear right wing segment 322 in unison and/or independently of one another.

When included, aircraft 700 comprises any suitable type of tilt mechanisms 430. As shown in FIG. 11, in some examples, each tilt mechanism 430 comprises one or more respective tilt mechanism actuators 450. As a more specific example, one or more tilt mechanisms 430 of aircraft 700 may be rotatable tilt mechanisms. In some such examples, the rotatable tilt mechanism include a rod that is operatively coupled to one or more portions of a respective wing segment and extends in an inboard direction to pass through a rotational element that is positioned along inboard portion 122 and/or fuselage 30 and permits selective and operative rotation of the rod. The rod also may be in operative contact with tilt mechanism actuator 450, such as a torque actuator, that is configured to selectively and operatively rotate the rod to tilt the respective one or more portions of the wing segment.

With continued reference to FIG. 11, in some examples, aircraft 700 comprises one or more propulsion units 400 that may be operatively coupled to forward wing segment 200. Additionally or alternatively, aircraft 700 comprises one or more flight control surfaces 180 disposed along rear wing segment 300.

FIG. 12 illustrates examples of aircraft 700 with wing assembly 100 oriented in pitched thrust configuration 154. As shown, forward wing segment 200 and rear wing segment 300 are tilted relative to inboard portion 122 and define forward wing segment airfoil 202 and rear wing segment airfoil 302, respectively. Forward left wing segment 220 and forward right wing segment 222 are tilted among forward wing segment pitched positions 254, and rear left wing segment 320 and rear right wing segment 322 are tilted among rear wing segment pitched positions 354. Forward left wing segment 220 and rear left wing segment 320 are spaced apart by separation 156 with passage volume 170 being defined therebetween. Similarly, forward right wing segment 222 and rear right wing segment 322 are spaced apart by separation 156 with passage volume 170 being defined therebetween. As such, wing assembly 100 of aircraft 700 may be described as having split-wing configuration 102.

FIGS. 13-14 illustrate examples of aircraft 10 indicated at and referred to herein as aircraft 800, in which FIG. 13 illustrates examples of aircraft 800 with wing assembly 100 oriented in forward thrust configuration 152 and FIG. 14 illustrates examples of aircraft 800 with wing assembly 100 oriented among pitched thrust configurations 154. With initial reference to FIG. 13, aircraft 800 comprises wing assembly 100 having forward wing segment 200, rear wing segment 300 and outboard portions 120 that are positioned within wing assembly 100 outboard of forward wing segment 200 and rear wing segment 300. Outboard portions 120 are fixedly positioned within airframe 20 with forward wing segment 200 and optionally rear wing segment 300 being configured to pivot relative to outboard portions 120. In some examples, forward wing segment 200 and rear wing segment 300 are operatively coupled to outboard portions 120 through rotatable couplers 126 that permit forward wing segment 200 and rear wing segment 300 to pivot relative to outboard portions 120 and fixedly position outboard portions 120 within airframe 20. As an example, each rotatable coupler 126 may include a boom structure that extends outwardly from fuselage 30 along, within, or proximate a respective wing segment to fixedly couple with an outboard portion 120 while permitting the respective wing segment to pivot or tilt.

With continued reference to FIG. 13, forward wing segment 200 is in forward wing segment forward thrust position 252 and rear wing segment 300 is in rear wing segment forward thrust position 352, with forward wing segment 200, rear wing segment 300, and outboard portions 120 defining continuous airfoil shape 130. Forward wing segment 200 and rear wing segment 300 span centerline 24 of aircraft 10 and may be operatively coupled to fuselage 30. As shown, aircraft 800 also comprises one or more tilt mechanisms 430, such as the tilt mechanism 430 discussed in more detail herein with reference to aircraft 600 and FIGS. 8-10, as well as propulsion units 400 that are operatively coupled to forward wing segment 200.

FIG. 14 illustrates examples of aircraft 800 with wing assembly 100 oriented among pitched thrust configurations 154. As shown, forward wing segment 200 is tilted among forward wing segment pitched positions 254 by tilt mechanism 430 and tilt mechanism actuators 450. Likewise, rear wing segment 300 is tilted among rear wing segment pitched positions 354 by tilt mechanism 430 and tilt mechanism actuator(s) 450. Forward wing segment 200 and rear wing segment 300 are tilted relative to outboard portions 120, and outboard portions 120 are fixedly positioned within airframe 20, such as by rotatable couplers 126. Further shown, forward wing segment 200 and rear wing segment 300 are spaced apart by separation 156 with passage volume 170 being defined therebetween. As such, wing assembly 100 of aircraft 800 may be described as having split-wing configuration 102. Propulsion units 400 are tilted with forward wing segment 200 and positioned therealong such that slipstreams generated by propulsion units 400 are directed within passage volume 170.

Turning back to FIGS. 1-2, in some examples, aircraft 10 comprises one or more power sources 60 that are configured to supply power to various actuators of aircraft 10, such as propulsion unit engines 410 that power propulsion units 400 or tilt mechanism actuators 450 that facilitate tilting of the wing segments. As an example, when propulsion units 400 and/or propulsion unit engines 410 are electrically powered, power sources 60 may be configured to supply electrical power to propulsion units 400 and/or propulsion unit engines 410. Similarly, in some examples, tilt mechanism actuators 450 are electrically powered and power sources 60 are configured to supply electrical power to tilt mechanism actuators 450. Thus, in some examples, aircraft 10 is a fully electrical aircraft 10 and power sources 60 only comprise batteries. In some examples, power sources 60 additionally or alternatively comprise liquid fuel (e.g., petroleum-based jet fuel), such as to power propulsion units 400 or propulsion unit engines 410. In some such examples, aircraft 10 is a hybrid electric aircraft that is powered by both electric batteries and fuel.

When included, power sources 60 are positioned within any suitable region of aircraft 10. As an example, one or more power sources may be positioned along and/or within fuselage 30. Additionally or alternatively, power sources may be positioned along or within any suitable region of wing assembly 100. As yet another example, one or more power sources 60 may be positioned within the component to which the one or more power sources 60 are configured to supply power.

In some examples, aircraft 10 additionally comprises a controller 50 that is programmed to control various actuators of aircraft 10 (e.g., propulsion units 400, propulsion unit engines 410, flight control surface actuators 184, and/or tilt mechanism actuators 450). A specific example of controller 50 is illustrated in FIG. 15. When included, controller 50 comprises a memory unit 54 and a processing unit 52. Memory unit 54 stores computer-readable instructions (the software) and processing unit 52 executes the stored computer-readable instructions to perform the various computer functions responsive to the various inputs, such as to selectively tilt forward wing segment 200.

When included, memory unit 54 comprises non-volatile (also referred to herein as “non-transitory”) memory 58 (e.g., ROM, PROM, and EPROM) and/or volatile (also referred to herein as “transitory”) memory 56 (e.g., RAM, SRAM, and DRAM). In some examples, processing unit 52 comprises integrated circuits including one or more of field-programmable gate arrays (FPGAs), application-specific integrated circuits (ASICs), digital signal processors (DSPs), microprocessors, microcontrollers, programmable array logic (PALs), and complex programmable logic devices (CPLDs).

As will be described in greater detail below, controller 50 is programmed to execute various methods, such as methods 500 schematically represented in FIG. 16.

FIG. 15 schematically shows controller 50 included in an example of electrical system 70 that may be comprised in aircraft 10. Electrical connections between components are illustrated in dashed dot lines, and mechanical connections between components are illustrated in solid lines. In this example, electrical system 70 comprises one or more power sources 60, controller 50, and various actuators that are controlled by controller 50. In the example of FIG. 15, only a propulsion unit 400, a propulsion unit engine 410, and a tilt mechanism 430 having one or more tilt mechanism actuators 450 that are configured to selectively actuate tilting of forward wing segment 200 are illustrated. However, FIG. 15 depicts an illustrative, non-exclusive example of electrical system 70, and in many examples, electrical system 70 comprises additional actuators, such as tilt mechanism actuators for actuating tilting of rear wing segment 300, flight control surface actuators, and/or additional actuators for actuating additional propulsion units that are not illustrated in the example of FIG. 15. Moreover, as discussed herein, the present disclosure is not limited to the electrical system 70 of the example of FIG. 15 for controlling aircraft 10, and controller 50 and/or power sources 60 additionally or alternatively may be utilized to control other components and/or aspects of aircraft 10, and/or may define related portions of other systems, such as liquid fuel delivery systems, to that illustrated in FIG. 15.

The one or more tilt mechanism actuators 450 are configured to selectively tilt forward wing segment 200 among the plurality of forward wing segment tilt positions. Each tilt mechanism actuator 450 comprises one or more of an electromechanical, pneumatic, and hydraulic actuator that is configured to be electronically controlled by controller 50. In the example of FIG. 15, propulsion unit engine 410 is an electric motor that is configured to selectively and operatively rotate powered rotor 402, such as to regulate thrust generated by propulsion unit 400 along thrust vector 420.

Controller 50 is in electrical communication (e.g., wired and/or wireless communication) with power sources 60, tilt mechanism actuator(s) 450, and propulsion unit engine 410. Controller 50 receives electrical power from power source(s) 60, and selectively distributes the electrical power provided by power source(s) 60 to tilt mechanism actuator(s) 450 and propulsion unit engine 410 according to a control scheme. In particular, methods 500 discussed below in relation to FIG. 16 describe an example control scheme that may be utilized by controller 50 to regulate the amount of electrical power supplied to tilt mechanism actuator(s) 450 and propulsion unit engine 410.

More generally, in the example of FIG. 15, controller 50 sends command signals (e.g., digital signals) to one or more of propulsion unit engine 410 and tilt mechanism actuator(s) 450 to adjust operation thereof. As described above, controller 50 is programmed to perform various actions, such as to control the actuators as described above, based on input. In particular, controller 50 comprises computer-readable instructions stored in non-transitory memory 58, wherein the computer-readable instructions comprise instructions for controlling one or more of propulsion unit engine 410 and tilt mechanism actuator(s) 450. Processing unit 52 is configured to execute the stored computer-readable instructions to control operation of one or more of propulsion unit engine 410 and tilt mechanism actuator(s) 450.

FIG. 16 is a flowchart that schematically represents illustrative, non-exclusive examples of methods 500 according to the present disclosure. Methods 500 optionally may be described as methods of operating an aircraft, methods of controlling an aircraft, methods of enhancing operation of an aircraft, and/or as methods of improving operation of an aircraft. In FIG. 16, some steps are illustrated in dashed boxes, indicating that such steps may be optional or may correspond to an optional version of methods 500. That said, not all methods 500 are required to include the steps illustrated in solid boxes. The methods and steps of FIG. 16 are not limiting and other methods and steps are within the scope of the present disclosure, including methods having greater than or fewer than the number of steps illustrated, as understood from the discussion herein. Each step or portion of methods 500 may be performed with utilizing aircraft 10 and/or portions thereof that are discussed in detail herein with reference to FIGS. 1-15. Likewise, any of the features, functions, and/or structures of the aircraft discussed herein with reference to FIG. 16 may be included in and/or utilized in aircraft 10 of FIGS. 1-15 without departing from the scope of the present disclosure.

In some examples, controller 50, as discussed above, is programmed to perform or otherwise facilitate or implement one or more of the methods and/or steps illustrated in FIG. 16 and/or discussed herein. In some examples, instructions for performing the various steps and/or methods described herein are stored as computer-readable instructions in the non-transitory memory of controller 50. The processing unit 52 of controller 50 is configured to execute the computer-readable instructions to perform the one or more steps and methods illustrated in FIG. 16. In other examples, instructions for performing the various steps and/or methods described herein are stored remotely from aircraft 10, such as in the example of an aircraft 10 that is configured to be controlled remotely. In other examples, one or more steps or portions of methods 500 are executed responsive to control by one or more pilots that are present in the aircraft and/or are controlling the aircraft remotely.

As illustrated in FIG. 16, methods 500 comprise controlling elevation of the aircraft at 505 and transitioning the aircraft to a cruise configuration at 530. The controlling elevation of the aircraft at 505 comprises controlling vectored thrust induced in the aircraft by one or more propulsion units at 520. The transitioning the aircraft to the cruise configuration at 530 comprises tilting a forward wing segment from a forward wing segment pitched position to a forward wing segment forward thrust position at 535 and supplying thrust to the aircraft with the propulsion units in a forward thrust vector at 550. The controlling elevation of the aircraft at 505 may include tilting the forward wing segment from the forward thrust position to among a plurality of forward wing segment pitched positions at 510, tilting a rear wing segment from a rear wing segment forward thrust position to among a plurality of rear wing segment pitched positions at 515, and/or directing airflow across the forward wing segment at 525. The transitioning the aircraft to the cruise configuration at 530 may include tilting the rear wing segment from among the rear wing segment pitched positions to the rear wing segment forward thrust position at 540 and/or extending transition panels to form one or more smooth transition surfaces at 545.

As discussed herein, the aircraft comprises a wing assembly having a forward wing segment and a rear wing segment, in which the forward wing segment is positioned forward of the rear wing segment within the wing assembly. The wing assembly is configured to be transitioned among a forward thrust configuration and a plurality of pitched thrust configurations. In the forward thrust configuration, the forward wing segment and the rear wing segment define a continuous airfoil shape. When the wing assembly is oriented among the pitched thrust configurations, the forward wing segment is spaced apart from at least a portion of the rear wing segment. The forward wing segment is configured to be tilted among a plurality of forward wing segment tilt positions that comprise a forward wing segment forward thrust position that corresponds to the forward thrust configuration of the wing assembly and a plurality of forward wing segment pitched positions that correspond to the plurality of pitched thrust configurations of the wing assembly. In some examples, the rear wing segment is configured to be tilted among a plurality of rear wing segment tilt positions that comprise a rear wing segment forward thrust position that corresponds to the forward thrust configuration of the wing assembly and a plurality of rear wing segment pitched positions that correspond to the plurality of pitched thrust configurations of the wing assembly.

In some examples, the controlling elevation of the aircraft at 505 comprises increasing elevation of the aircraft. Additionally or alternatively, the controlling elevation of the aircraft at 505 comprises decreasing elevation of the aircraft. The controlling elevation of the aircraft at 505 is performed with any suitable sequence or timing within methods 500. As examples, the controlling elevation of the aircraft at 505 may be performed prior to and/or subsequent to transitioning the aircraft to the cruise configuration at 530. The controlling elevation of the aircraft at 505 additionally or alternatively is performed with any suitable timing during operation of the aircraft. As examples, the controlling elevation of the aircraft at 505 may be performed during takeoff operations, during landing operations, and/or at any suitable time while the aircraft is airborne. As more specific examples, the controlling elevation of the aircraft at 505 may include increasing elevation of the aircraft during takeoff operations and/or may include decreasing elevation of the aircraft during landing operations.

In some examples, the wing assembly is oriented among the pitched configurations and the forward wing segment correspondingly is tilted among the forward wing segment pitched positions during the controlling elevation of the aircraft at 505. With this in mind, as shown in FIG. 16, in some examples the controlling elevation of the aircraft at 505 comprises tilting the forward wing segment from the forward wing segment forward thrust position to among the forward wing segment forward thrust positions at 510. For example, the tilting at 510 may be performed when the wing assembly is in the forward thrust configuration, when the forward wing segment is in the forward wing segment forward thrust position, and/or when the aircraft is in the cruise configuration prior to the controlling elevation of the aircraft at 505.

When included, the tilting the forward wing segment at 510 comprises tilting the forward wing segment to any suitable forward wing segment pitched tilt position. As an example, when the controlling elevation of the aircraft at 505 comprises increasing elevation of the aircraft and/or is performed during takeoff operations, the tilting at 510 may comprise tilting the forward wing segment to a pitched angle in the range of 80°-90°. As another example, when the controlling elevation of the aircraft at 505 comprises decreasing elevation of the aircraft and/or is performed during landing operations, the tilting at 510 may comprise tilting the forward segment to a pitched angle in the range of 90°-95°. In some such examples, the tilting at 510 comprises progressively tilting the forward wing segment through a range of pitched angles as the aircraft decelerates until the forward wing segment reaches a pitched angle in the range of 90°-95° and the ceases substantial forward motion. In some examples, the tilting at 510 is performed to increase lift in the forward wing segment and/or such that the forward wing segment defines the forward wing segment airfoil. Additionally or alternatively, in some examples the tilting at 510 is performed to increase drag on the forward wing segment, such as during landing operations. As discussed herein, in any of the above examples, the tilting at 510 may comprise utilizing one or more tilt mechanisms and/or one or more tilt mechanism actuators.

When included, the tilting the forward wing segment at 510 is performed with any suitable sequence or timing within methods 500. As examples, the tilting at 510 may be performed prior to, and/or subsequent to the transitioning the aircraft to the cruise configuration at 530. The tilting at 510 also may be performed prior to, subsequent to, and/or substantially simultaneously with tilting the rear wing segment at 515 and/or controlling vectored thrust in the aircraft at 520. Additionally or alternatively, the tilting at 510 is performed prior to the directing airflow across the forward wing segment at 525.

With continued reference to FIG. 16, in some examples, the controlling elevation of the aircraft at 505 comprises tilting the rear wing segment from the rear wing segment forward thrust position to among the rear wing segment pitched thrust positions at 515. The tilting at 515 may be performed in a similar manner to the tilting at 510 and/or may include substantially similar steps to the tilting at 510. As discussed herein with reference to the tilting the forward wing segment at 510, the tilting at 515 may be performed when the rear wing segment is in the rear wing segment forward thrust position, the wing assembly is in the forward thrust position, and/or the aircraft is in the cruise configuration prior to the controlling the elevation of the aircraft at 505.

When included, the tilting rear wing segment at 515 comprises tilting the rear wing segment to any suitable rear wing segment pitched position. In some examples, the tilting the rear wing segment at 515 comprises tilting the rear wing segment to a rear wing segment pitched position that corresponds to a forward wing segment pitched position, as discussed herein. The tilting the rear wing segment at 515 may be performed when the controlling elevation of the aircraft at 515 comprises increasing elevation of the aircraft and/or when the controlling the elevation of the aircraft at 515 comprises decreasing the elevation of the aircraft, such as discussed herein with respect to the tilting the forward wing segment at 515. The tilting the rear wing segment additionally or alternatively may be performed during landing operations, during takeoff operations and/or may include tilting the rear wing segment to any suitable pitched angle, such as discussed herein with respect to the tilting the forward wing segment at 515. Similarly, in some examples, the tilting the rear wing segment at 515 is performed to increase lift in the rear wing segment and/or such that the rear wing segment defines the rear wing segment airfoil. Additionally or alternatively, in some examples the tilting at 515 is performed to increase drag on the rear wing segment. As discussed herein, in some examples, the tilting the rear wing segment at 515 comprises utilizing one or more tilt mechanisms and/or tilt mechanism actuators.

As shown in FIG. 16, the controlling elevation of the aircraft at 505 comprises controlling vectored thrust induced in the aircraft by one or more propulsion units at 520. The controlling vectored thrust at 520 is performed with any suitable sequence or timing within methods 500. As examples, the controlling vectored thrust at 520 may be performed subsequent to, or substantially simultaneously with tilting the forward wing segment at 510, prior to, subsequent to, or substantially simultaneously with tilting the rear wing segment at 515, and/or prior to directing airflow at 525. The controlling vectored thrust at 520 also is performed with any suitable timing during operation of the aircraft, for example, during takeoff, during landing, and/or until the aircraft has reached a cruising altitude.

The controlling vectored thrust at 520 may comprise activating the propulsion units, increasing a magnitude of thrust induced by the one or more propulsion units, decreasing the magnitude of thrust induced by the one or more propulsion units, and/or maintaining the magnitude of thrust induced by the one or more propulsion units. For example, when the controlling elevation of the aircraft at 505 comprises increasing elevation of the aircraft, the controlling vectored thrust at 520 may comprise increasing the magnitude of thrust induced by the one or more propulsion units, and when the controlling elevation of the aircraft at 505 comprises decreasing elevation of the aircraft, the controlling vectored thrust at 520 may comprise decreasing the magnitude of thrust induced by the one or more propulsion units.

In some examples, the controlling vectored thrust at 520 comprises controlling the pitch of the vectored thrust, as discussed herein. For example, when the controlling elevation of the aircraft at 505 comprises increasing elevation of the aircraft, the controlling vectored thrust at 520 may comprise increasing the pitch of the vectored thrust and/or inducing thrust in the aircraft with the one or more propulsion units along a pitched vector that is angled in a direction that opposes a direction of gravity. With this in mind, the controlling vectored thrust at 520 may include setting the pitch of the vectored thrust within any suitable range, such as in the range of 70°-95° relative to the longitudinal axis of the aircraft during a vertical takeoff. In view of the above, in some examples, the controlling vectored thrust at 520 comprises decreasing thrust in a horizontal direction, for example, to slow the forward velocity of the aircraft, such as during landing operations.

As discussed herein, in some examples, the one or more propulsion units are operatively coupled to the forward wing segment and configured to be tilted with the forward wing segment. In some such examples, the controlling vectored thrust at 520 comprises tilting the forward wing segment to a forward wing segment pitched thrust position and inducing thrust in the aircraft with the one or more propulsion units in a corresponding pitched vector. Stated another way, in some examples, the controlling vectored thrust at 520 comprises tilting the forward wing segment at 510 to control the pitch of the vectored thrust.

As shown in FIG. 16, in some examples, the controlling elevation of the aircraft at 505 comprises directing airflow across the forward wing segment at 525. As discussed herein, in some examples, when the wing assembly is oriented among the pitched thrust configurations, the forward wing segment and the rear wing segment are spaced apart and define the passage volume therebetween. In some examples, the passage volume is configured to direct airflow across the upper surface of the forward wing segment, such as to prevent airflow separation from the forward wing segment and/or to prevent wing stall. Additionally or alternatively, in some examples, the passage volume is configured to channel slipstreams generated by the one or more propulsion units, such as to restrict contraction thereof and/or promote thrust generation by the one or more propulsion units.

With this in mind, in some examples, the directing airflow at 525 comprises directing airflow within the passage volume defined by the forward wing segment and the rear wing segment. In some examples, the directing airflow at 525 comprises restricting airflow separation from the upper surface of the forward wing segment and/or restricting wing stall during the tilting the forward wing segment at 510 and/or tilting the rear wing segment at 515. Additionally or alternatively, in some examples, the directing airflow comprises channeling slipstreams generated by the one or more propulsion units during the controlling the vectored thrust at 520.

The directing airflow at 525 may be performed with any suitable sequence or timing within methods 500. As examples, the directing airflow at 525 may be performed substantially simultaneously with the tilting the forward wing segment at 510, tilting the rear wing segment at 515, and/or the controlling vectored thrust at 520.

With continued reference to FIG. 16, methods 500 comprise transitioning the aircraft to a cruise configuration at 530. The transitioning at 530 is performed with any suitable sequence or timing within methods 500. As examples, the transitioning at 530 may be performed prior to and/or subsequent to the controlling elevation of the aircraft at 505. Additionally or alternatively, the transitioning at 530 is performed with any suitable timing during operation of the aircraft. For example, the transitioning at 530 may be performed subsequent to a takeoff operation, prior to a landing operation, and/or when the aircraft has reached a cruising altitude.

In some examples, the transitioning the aircraft to the cruise configuration at 530 is performed to configure the aircraft for horizontal flight and/or flight at a cruising altitude. In some examples, the transitioning the aircraft to the cruise configuration at 530 comprises reducing drag on the aircraft. More specifically, the transitioning the aircraft to the cruise configuration at 530 comprises transitioning the wing assembly to the forward thrust configuration. As such, the transitioning at 530 comprises forming the continuous airfoil shape with the forward wing segment and the rear wing segment.

As illustrated in FIG. 16, the transitioning the aircraft to the cruise configuration at 530 comprises tilting the forward wing segment from among the pitched tilt positions to the forward thrust position at 535. As discussed herein, in some examples, the tilting the forward wing segment at 535 comprises utilizing one or more tilt mechanisms and/or one or more tilt mechanism actuators. In some examples, the tilting the forward wing segment at 535 comprises forming the continuous airfoil shape with the forward wing segment and the rear wing segment. In some examples, the tilting at 535 comprises progressively tilting the forward wing segment through a range of pitched angles as the forward velocity of the aircraft increases. In some examples, the tilting the forward wing segment at 535 comprises overlapping the upper surface of the trailing edge region of the forward wing segment with the lower surface of the leading edge region of the rear wing segment. Alternatively, in some examples, the tilting the forward wing segment at 535 comprises positioning the trailing edge region of the forward wing segment proximate the leading edge region of the rear wing segment. In some examples, the tilting the forward wing segment at 535 is performed to induce lift in the wing assembly in the forward thrust configuration.

The tilting the forward wing segment at 535 is performed with any suitable sequence or timing within methods 500, such as prior to tilting the rear wing segment at 540, substantially simultaneously with tilting the rear wing segment at 540, prior to extending the transition panel(s) at 545, prior to supplying thrust to the aircraft at 550, and/or substantially simultaneously with supplying thrust to the aircraft at 550.

With continued reference to FIG. 16, in some examples, the transitioning the aircraft to the cruise configuration at 530 comprises tilting the rear wing segment from the rear wing segment pitched position to the rear wing segment forward thrust position at 540. As discussed herein, in some examples the tilting the rear wing segment at 540 comprises utilizing one or more tilt mechanisms and/or one or more tilt mechanism actuators. In some examples, the tilting at 540 comprises progressively tilting the rear wing segment through a range of pitched angles as the forward velocity of the aircraft increases. In some examples, the tilting the rear wing segment at 540 comprises forming the continuous airfoil shape with the forward wing segment and the rear wing segment. In some examples, the tilting the rear wing segment at 540 comprises tilting the rear wing segment in unison with the tilting the forward wing segment at 535, such that each rear wing segment tilt position corresponds to each forward wing segment tilt position during the tilting of the forward and rear wing segments at 535 and 540. In some examples, the tilting the rear wing segment at 540 comprises overlapping and/or conforming the lower surface of the leading edge region of the rear wing segment with the upper surface of the trailing edge region of the forward wing segment. Alternatively, in some examples, the tilting the rear wing segment at 540 comprises positioning the leading edge region of the rear wing segment proximate the trailing edge region of the forward wing segment. In some examples, the tilting the rear wing segment at 540 is performed to induce lift in the wing assembly in the forward thrust configuration.

When included, the tilting the rear wing segment at 540 is performed with any suitable sequence or timing within methods 500, such as prior to, substantially simultaneously with, and/or subsequent to the tilting the forward wing segment at 535. Additionally or alternatively, the tilting the rear wing segment at 540 is performed prior to extending the transition panels at 545, and/or prior, substantially simultaneously with, and/or subsequent to supplying thrust to the aircraft at 550.

As indicated in FIG. 16, in some examples, methods 500 comprise extending one or more transition panels between the forward wing segment and the rear wing segment to form one or more smooth transition surfaces at 545. As discussed herein, in some examples, the wing assembly comprises one or more transition panels, and each transition panel is configured to form a smooth transition surface between the forward wing segment and the rear wing segment when the wing assembly is in the forward thrust configuration and/or when the forward wing segment and the rear wing segment define the continuous airfoil shape with the forward wing segment and the rear wing segment. In some examples, the one or more transition panels are extendably coupled to the forward wing segment and are configured to be selectively and operatively extended from and retracted to the forward wing segment. In some examples, the wing assembly comprises an upper transition panel that is operatively coupled to an upper surface of a trailing half of the forward wing segment and a lower transition panel that is operatively coupled to a lower surface of a trailing half of the forward wing segment.

In view of the above, in some examples, the extending the transition panel(s) at 545 comprises selectively extending the upper transition panel from the upper surface of the trailing half of the forward wing segment to operatively contact and/or rest upon the upper surface of the leading half of the rear wing segment to form the smooth transition surface therebetween. Similarly, in some examples the extending the transition panel(s) at 545 comprises selectively extending the lower transition panel from the lower surface of the trailing half of the forward wing segment to the lower surface of the leading half of the rear wing segment. In any such examples, the extending the transition panels at 545 may comprise smoothing the continuous airfoil shape defined by the forward wing segment and the rear wing segment, such as to reduce drag on the wing assembly in the forward thrust configuration and/or such as to improve airflow characteristics over the wing assembly in the forward thrust configuration.

When included, the extending the transition panels at 545 is performed with any suitable sequence or timing within methods 500, such as subsequent to the tilting the forward wing segment at 535, subsequent to the tilting the rear wing segment at 540, and/or prior to, substantially simultaneously with, and/or subsequent to supplying thrust at 550.

With continued reference to FIG. 16, the transitioning the aircraft to the cruise configuration at 530 comprises supplying thrust to the aircraft with the one or more propulsion units in a forward thrust vector at 550. The supplying thrust to the aircraft at 550 comprises supplying thrust in any suitable forward thrust vector, such that the thrust supplied at 550 may propel the aircraft in a generally horizontal direction and/or such that the thrust supplied at 550 propels the aircraft in a forward direction, such as during taxiing and/or at a cruising altitude. The supplying thrust at 530 comprises supplying thrust in a forward thrust vector having any suitable pitch, such as a pitch in the range of 0°-10° relative to the longitudinal axis of the aircraft. With this in mind, in some examples, the supplying thrust at 550 comprises controlling the pitch of the vectored thrust induced by the one or more propulsion units. In some such examples, the supplying the thrust at 550 comprises reducing the pitch of the vectored thrust, such as from the pitched thrust vector of step 520 to the forward thrust vector.

As discussed herein, in some examples, the one or more propulsion units are operatively coupled to the forward wing segment and configured to be tilted with the forward wing segment. In some such examples, the supplying thrust at 550 comprises controlling the pitch of the vectored thrust by tilting the forward wing segment from among the forward wing segment pitched positions to the forward wing segment forward thrust position. In some such examples, the pitch of the forward thrust vector corresponds to the forward wing segment forward thrust position.

In some examples, the supplying thrust to the aircraft at 550 comprises controlling the magnitude of the vectored thrust supplied by the one or more propulsion units, such as by increasing the magnitude of the vectored thrust, decreasing the magnitude of the vectored thrust and/or maintaining the magnitude of the vectored thrust.

The supplying thrust to the aircraft at 550 is performed with any suitable sequence or timing within methods 500, such as substantially simultaneously with, or subsequent to, the tilting the forward wing segment at 535 and/or the tilting the rear wing segment at 540, and/or prior to, substantially simultaneously with, and/or subsequent to the extending the transition panels at 545.

While the discussion herein of FIG. 16 and methods 500 focuses on the forward wing segment and the rear wing segment, it is within the scope of the present disclosure that similar methods may be performed when the wing assembly comprises one or more additional rear wing segments. In particular, the discussion relating to the rear wing segment and/or the features, functions, and/or operation there of equally may apply to each additional rear wing segment.

Illustrative, non-exclusive examples of inventive subject matter according to the present disclosure are described in the following enumerated paragraphs:

A1. An aircraft comprising:

an airframe comprising a wing assembly that includes a forward wing segment and a rear wing segment, wherein the forward wing segment is positioned within the airframe forward of at least a portion of the rear wing segment, and wherein the wing assembly is configured to be selectively transitioned among:
(i) a forward thrust configuration in which the forward wing segment and the rear wing segment define a continuous airfoil shape; and
(ii) a plurality of pitched thrust configurations in which the forward wing segment and at least the portion of the rear wing segment are spaced apart;
wherein the forward wing segment is pivotally coupled within the airframe and configured to be selectively tilted among a plurality of forward wing segment tilt positions, wherein the plurality of forward wing segment tilt positions comprises a forward wing segment forward thrust position and a plurality of forward wing segment pitched positions, wherein the forward wing segment forward thrust position corresponds to the forward thrust configuration of the wing assembly and the plurality of forward wing segment pitched positions corresponds to the plurality of pitched thrust configurations of the wing assembly.

A2. The aircraft of paragraph A1, wherein the forward wing segment defines a forward wing segment airfoil when the wing assembly is among the plurality of pitched thrust configurations.

A3. The aircraft of any of paragraphs A1-A2, wherein the rear wing segment defines a rear wing segment airfoil when the wing assembly is among the plurality of pitched thrust configurations, and wherein the forward wing segment airfoil and the rear wing segment airfoil define discrete airfoil shapes when the wing assembly is among the plurality of pitched thrust configurations.

A3.1 The aircraft of paragraph A3, wherein a/the forward wing segment airfoil and the rear wing segment airfoil are configured to induce lift in the aircraft.

A4. The aircraft of any of paragraphs A1-A3, wherein when the wing assembly is among the plurality of pitched thrust configurations, the forward wing segment is spaced apart from the rear wing segment along a longitudinal axis of the aircraft.

A5. The aircraft of any of paragraphs A1-A4, wherein the plurality of forward wing segment tilt positions span at least 5° and/or at most 95° relative to a longitudinal axis of the aircraft.

A6. The aircraft of any of paragraphs A1-A5, wherein the rear wing segment is pivotally coupled within the airframe and configured to be selectively tilted among a plurality of rear wing segment tilt positions, wherein the plurality of rear wing segment tilt positions comprises a rear wing segment forward thrust position and a plurality of rear wing segment pitched positions, wherein the rear wing segment forward thrust position corresponds to the forward thrust configuration of the wing assembly and the plurality of rear wing segment pitched positions corresponds to the plurality of pitched thrust configurations of the wing assembly.

A7. The aircraft of paragraph A6, wherein the plurality of rear wing segment tilt positions span at least 5° and/or at most 95° relative to a/the longitudinal axis of the aircraft.

A8. The aircraft of any of paragraphs A1-A7, wherein the aircraft comprises one or more tilt mechanisms that are configured to selectively tilt the forward wing segment among the plurality of forward wing segment tilt positions.

A9. The aircraft of paragraph A8, wherein the one or more tilt mechanisms further are configured to operatively support and selectively retain the forward wing segment in each forward wing segment tilt position of the plurality of forward wing segment tilt positions.

A10. The aircraft of any of paragraphs A8-A9, wherein the one or more tilt mechanisms comprises one or more tilt mechanism actuators that are configured to facilitate tilting of the forward wing segment among the plurality of forward wing segment tilt positions.

A11. The aircraft of any of paragraphs A8-A10 when depending from paragraph A6, wherein the one or more tilt mechanisms further are configured to selectively tilt the rear wing assembly among the plurality of rear wing segment tilt positions.

A12. The aircraft of paragraph A11, wherein the one or more tilt mechanisms further are configured to operatively support and selectively retain the rear wing segment in each rear wing segment tilt position of the plurality of rear wing segment tilt positions.

A13. The aircraft of any of paragraphs A11-A12, wherein a/the one or more tilt mechanism actuators of the one or more tilt mechanisms further are configured to facilitate tilting of the rear wing segment among the plurality of rear wing segment tilt positions.

A14. The aircraft of any of paragraphs A11-A13, wherein the one or more tilt mechanisms comprises a forward wing segment tilt mechanism that is configured to selectively tilt the forward wing segment among the plurality of forward wing segment tilt positions and a rear wing segment tilt mechanism that is configured to selectively tilt the rear wing segment among the plurality of rear wing segment tilt positions.

A15. The aircraft of any of paragraphs A11-A14, wherein the one or more tilt mechanisms are configured to tilt the forward wing segment among the plurality of forward wing segment tilt positions and the rear wing segment among the plurality of rear wing segment tilt positions in unison.

A16. The aircraft of paragraph A15, wherein each forward wing segment tilt position corresponds to each rear wing segment tilt position.

A17. The aircraft of paragraph A16, wherein a chord of the forward wing segment is substantially aligned with a chord of the rear wing segment when the forward wing segment tilt position corresponds to the rear wing segment tilt position.

A18. The aircraft of any of paragraphs A15-A17, wherein when the forward wing segment is tilted among the plurality of forward wing segment pitched positions and the rear wing segment is tilted among the plurality of rear wing segment tilt positions, the forward wing segment and the rear wing segment define a passage volume therebetween.

A19. The aircraft of paragraph A18, wherein the passage volume is configured to channel slipstreams generated by one or more propulsion units that are included in the aircraft.

A20. The aircraft of paragraph A19, wherein the passage volume is configured to restrict contraction of the slipstreams and promote thrust generation by the one or more propulsion units.

A21. The aircraft of any of paragraphs A18-A20, wherein the passage volume is configured to direct airflow across an upper surface of the forward wing segment and prevent airflow separation from the upper surface of the forward wing segment.

A22. The aircraft of any of paragraphs A18-A21, wherein the passage volume is configured to benefit a maximum lift coefficient of the wing assembly.

A23. The aircraft of any of paragraphs A18-A22, wherein the passage volume is configured to prevent wing stall when the wing assembly is transitioned among the forward thrust configuration and the plurality of pitched thrust configurations.

A24. The aircraft of any of paragraphs A1-A23, wherein the forward wing segment spans across a centerline of the aircraft.

A25. The aircraft of any of paragraphs A1-A24, wherein the rear wing segment spans across a/the centerline of the aircraft.

A26. The aircraft of any of paragraphs A1-A25, wherein the forward wing segment spans an entire wingspan of the wing assembly.

A27. The aircraft of any of paragraphs A1-A26, wherein the rear wing segment spans an entire wingspan of the wing assembly.

A28. The aircraft of any of paragraphs A1-A25, wherein the forward wing segment spans a spanwise portion of the wing assembly.

A29. The aircraft of paragraph A28, wherein the rear wing segment spans a spanwise portion of the wing assembly.

A30. The aircraft of any of paragraphs A28-A29, wherein the wing assembly comprises outboard portions that are fixedly positioned within the airframe, and wherein the outboard portions are positioned within the wing assembly outboard of the forward wing segment.

A31. The aircraft of paragraph A30, wherein the forward wing segment is pivotally coupled to the outboard portions and is configured to be selectively tilted relative to the outboard portions.

A32. The aircraft of any of paragraphs A30-A31, wherein the rear wing segment is pivotally coupled to the outboard portions and configured to be selectively tilted relative to the outboard portions.

A33. The aircraft of paragraph A30-A31, wherein the rear wing segment is fixedly positioned within the airframe and fixedly coupled to the outboard portions.

A34. The aircraft of any of paragraphs A28-A33, wherein the wing assembly comprises an inboard portion that is fixedly positioned within the airframe.

A35. The aircraft of paragraph A34, wherein the forward wing segment comprises a forward left wing segment and a forward right wing segment, and wherein the inboard portion is positioned within the wing assembly inboard of the forward left wing segment and the forward right wing segment.

A36. The aircraft of paragraph A35, wherein the forward wing segment is pivotally coupled to the inboard portion and configured to be selectively tilted relative to the inboard portion.

A37. The aircraft of any of paragraphs A35-A36, wherein the rear wing segment comprises a rear left wing segment and a rear right wing segment, and wherein the inboard portion is positioned within the wing assembly inboard of the rear left wing segment and the rear right wing segment.

A38. The aircraft of any of paragraphs A34-A37, wherein the rear wing segment is pivotally coupled to the inboard portion and configured to be selectively tilted relative to the inboard portion.

A39. The aircraft of any of paragraphs A34-A37, wherein the rear wing segment is fixedly positioned within the airframe and is fixedly coupled to the inboard portion.

A40. The aircraft of any of paragraphs A1-A39, wherein a trailing edge region of the forward wing segment and a leading edge region of the rear wing segment overlap when the wing assembly is in the forward thrust configuration.

A41. The aircraft of paragraph A40, wherein an upper surface of the trailing edge region of the forward wing segment overlaps with a lower surface of the leading edge region of the rear wing segment.

A42. The aircraft of any of paragraphs A1-A39, wherein a trailing edge region of the forward wing segment is positioned proximate to a leading edge region of the rear wing segment when the wing assembly is in the forward thrust configuration.

A43. The aircraft of any of paragraphs A1-A42, wherein a thickness of the forward wing segment is greater than a thickness of the rear wing segment.

A44. The aircraft of any of paragraphs A1-A43, wherein the wing assembly comprises one or more transition panels that are configured to form one or more smooth transition surfaces between the rear wing segment and the forward wing segment when the wing assembly is in the forward thrust configuration.

A45. The aircraft of paragraph A44, wherein the one or more transition panels comprises one or more of an upper transition panel that is configured to form a smooth transition surface between an upper surface of the rear wing segment and an upper surface of the forward wing segment and a lower transition panel that is configured to form a smooth transition surface between a lower surface of the rear wing segment and a lower surface of the forward wing segment.

A46. The aircraft of any of paragraphs A44-A45, wherein the one or more transition panels extend from a trailing half of the forward wing segment to operatively contact a leading half of the rear wing segment when the wing assembly is in the forward thrust configuration.

A47. The aircraft of any of paragraphs A44-A46, wherein the one or more transition panels are configured to adopt a flush fit with an airfoil surface of the forward wing segment when the wing assembly is selectively transitioned to among the plurality of pitched thrust configurations.

A48. The aircraft of any of paragraphs A44-A47, wherein the one or more transition panels are configured to be selectively and operatively retracted from operative contact with the rear wing segment when the wing assembly is selectively transitioned from the forward thrust configuration to among the plurality of pitched thrust configurations, and wherein the one or more transition panels are configured to be selectively and operatively extended to operatively contact the rear wing segment when the wing assembly is selectively and operatively transitioned to the forward thrust configuration from among the plurality of pitched thrust configurations.

A49. The aircraft of any of paragraphs A1-A48, wherein the aircraft further comprises one or more propulsion units operatively coupled to the airframe that are configured to supply thrust to the aircraft when the wing assembly is in the forward thrust configuration and when the wing assembly is among the plurality of pitched thrust configurations.

A50. The aircraft of paragraph A49, wherein the one or more propulsion units comprises one or more powered rotors.

A50.1. The aircraft of any of paragraphs A49-A50, wherein the one or more propulsion units comprise one or more jet engines.

A51. The aircraft of any of paragraph A49-A50.1, wherein the aircraft comprises one or more units that are operatively coupled to the wing assembly.

A51.1 The aircraft of any of paragraphs A49-A51 wherein the one or more propulsion units are operatively coupled to the forward wing segment.

A51.2. The aircraft of paragraph A51.1, wherein the one or more propulsion units are configured to be tilted with the forward wing segment among the plurality of forward wing segment tilt positions, and wherein the one or more propulsion units are configured to supply thrust to the aircraft along a plurality of thrust vectors that correspond to the plurality of forward wing segment tilt positions.

A52. The aircraft of any of paragraphs A51.1-A51.2, wherein the one or more propulsion units are operatively coupled to the forward wing segment proximate leading edge regions of the forward wing segment.

A53. The aircraft of any of paragraphs A1-A52, wherein the aircraft is a tiltwing aircraft, and wherein the wing assembly comprises a split-wing configuration.

A54. The aircraft of paragraph A53, wherein the split-wing configuration of the wing assembly is configured to prevent the wing assembly from interfering with slipstreams generated by a/the one or more propulsion units and benefit thrust efficiency of the one or more propulsion units when the wing assembly is among the plurality of pitched thrust configurations.

A55. The aircraft of any of paragraphs A53-A54, wherein the wing assembly defines a frontal area when the wing assembly is among the plurality of pitched thrust configurations, wherein the frontal area of the wing assembly is smaller than a sum of frontal areas defined by each wing segment. A56. The aircraft of any of paragraphs A53-A55, wherein the split-wing configuration promotes high control authority over the aircraft during vertical flight in the presence of crosswinds.

A57. The aircraft of any of paragraphs A1-A56, wherein the wing assembly further comprises one or more additional rear wing segments that are positioned within the wing assembly rearwardly of the rear wing segment.

A58. The aircraft of paragraph A57, wherein the one or more additional rear wing segments are configured to define the continuous airfoil shape with the forward wing segment and the rear wing segment when the wing assembly is oriented among the plurality of pitched thrust configurations.

A59. The aircraft of any of paragraphs A57-A58, wherein the one or more additional rear wing segments are spaced apart from at least a portion of the rear wing segment when the wing assembly is among the plurality of pitched thrust configurations.

A60. The aircraft of any of paragraphs A57-A59, wherein the one or more additional rear wing segments each define an additional rear wing segment airfoil shape when the wing assembly is among the plurality of pitched thrust configurations.

A61. The aircraft of any of paragraphs A57-A60, wherein each additional rear wing segment is configured to be selectively tilted among a plurality of additional rear wing segment tilt positions, wherein the plurality of additional rear wing segment tilt positions comprises an additional rear wing segment forward thrust position that corresponds to the forward thrust configuration of the wing assembly and a plurality of additional rear wing segment pitched thrust positions that correspond the plurality of pitched thrust configurations of the wing assembly.

A62. The aircraft of any of paragraphs A1-A61, further comprising a controller, the controller comprising:

non-transitory memory comprising computer readable instructions for executing the methods of any of paragraphs B1-B8; and

a processor for executing the computer readable instructions to perform the methods of any of paragraphs B1-B8.

B1. A method of operating an aircraft that comprises a wing assembly having a forward wing segment and a rear wing segment, the method comprising:

controlling elevation of the aircraft by controlling vectored thrust induced in the aircraft by one or more propulsion units; and

transitioning the aircraft to a cruise configuration by:
(i) selectively tilting the forward wing segment from a forward wing segment pitched position to a forward wing segment forward thrust position in which the forward wing segment and the rear wing segment define a continuous airfoil shape; and
(ii) supplying thrust to the aircraft with the one or more propulsion units in a forward thrust vector that corresponds to the forward thrust position of the forward wing segment.

B2. The method of paragraph B1, wherein the one or more propulsion units are operatively coupled to the forward wing segment, and wherein the controlling the vectored thrust induced in the aircraft by the one or more propulsion units comprises controlling a pitch of the vectored thrust by tilting the forward wing segment to a forward wing segment pitched position.

B3. The method of any of paragraphs B1-B2, wherein the controlling elevation of the aircraft further comprises selectively tilting the forward wing segment from a forward wing segment forward thrust position to a/the forward wing segment pitched position.

B4. The method of any of paragraphs B1-B3, wherein the controlling elevation of the aircraft further comprises selectively tilting the rear wing segment from a rear wing segment forward thrust position to a rear wing segment pitched position.

B5. The method of paragraph B4, wherein when the forward wing segment is in the forward wing segment pitched position and the rear wing segment is in the rear wing segment pitched position, the forward wing segment and the rear wing segment are spaced apart and define a passage volume therebetween.

B6. The method of paragraph B4, wherein the controlling elevation of the aircraft further comprises directing airflow across an upper surface of the forward wing segment with the passage volume.

B7. The method of any of paragraphs B1-B6, wherein the transitioning the aircraft to the cruise configuration further comprises selectively extending one or more transition panels from a trailing half of the forward wing segment to contact a leading half of the rear wing segment and form one or more smooth transition surfaces between the forward wing segment and the rear wing segment.

B8. The method of any of paragraphs B1-B7, wherein the aircraft comprises the aircraft of any of paragraphs A1-A62.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the term “and/or” placed between a first entity and a second entity means one of (1) the first entity, (2) the second entity, and (3) the first entity and the second entity. Multiple entries listed with “and/or” should be construed in the same manner, i.e., “one or more” of the entities so conjoined. Other entities optionally may be present other than the entities specifically identified by the “and/or” clause, whether related or unrelated to those entities specifically identified. Thus, as a non-limiting example, a reference to “A and/or B,” when used in conjunction with open-ended language such as “comprising,” may refer, in one example, to A only (optionally including entities other than B); in another example, to B only (optionally including entities other than A); in yet another example, to both A and B (optionally including other entities). These entities may refer to elements, actions, structures, steps, operations, values, and the like.

The various disclosed elements of apparatuses and steps of methods disclosed herein are not required to all apparatuses and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

1. An aircraft comprising:
an airframe comprising a wing assembly that includes a forward wing segment and a rear wing segment, wherein the forward wing segment is positioned within the airframe forward of at least a portion of the rear wing segment, and wherein the wing assembly is configured to be selectively transitioned among:
(i) a forward thrust configuration in which the forward wing segment and the rear wing segment define a continuous airfoil shape; and
(ii) a plurality of pitched thrust configurations in which the forward wing segment and at least the portion of the rear wing segment are spaced apart;
wherein the forward wing segment is pivotally coupled within the airframe and configured to be selectively tilted among a plurality of forward wing segment tilt positions, wherein the plurality of forward wing segment tilt positions comprises a forward wing segment forward thrust position and a plurality of forward wing segment pitched positions, wherein the forward wing segment forward thrust position corresponds to the forward thrust configuration of the wing assembly and the plurality of forward wing segment pitched positions corresponds to the plurality of pitched thrust configurations of the wing assembly.

2. The aircraft of claim 1, wherein the forward wing segment defines a forward wing segment airfoil when the wing assembly is among the plurality of pitched thrust configurations.

3. The aircraft of claim 2, wherein the rear wing segment defines a rear wing segment airfoil when the wing assembly is among the plurality of pitched thrust configurations, and wherein the forward wing segment airfoil and the rear wing segment airfoil define discrete airfoil shapes when the wing assembly is among the plurality of pitched thrust configurations.

4. The aircraft of claim 3, wherein the forward wing segment airfoil and the rear wing segment airfoil are configured to induce lift in the aircraft.

5. The aircraft claim 1, wherein the rear wing segment is pivotally coupled within the airframe and configured to be selectively tilted among a plurality of rear wing segment tilt positions, wherein the plurality of rear wing segment tilt positions comprises a rear wing segment forward thrust position and a plurality of rear wing segment pitched positions, wherein the rear wing segment forward thrust position corresponds to the forward thrust configuration of the wing assembly and the plurality of rear wing segment pitched positions corresponds to the plurality of pitched thrust configurations of the wing assembly.

6. The aircraft of claim 5, wherein the aircraft comprises one or more tilt mechanisms, and wherein the one or more tilt mechanisms are configured to tilt the forward wing segment among the plurality of forward wing segment tilt positions and the rear wing segment among the plurality of rear wing segment tilt positions in unison.

7. The aircraft of claim 5, wherein when the forward wing segment is tilted among the plurality of forward wing segment pitched positions and the rear wing segment is tilted among the plurality of rear wing segment tilt positions, the forward wing segment and the rear wing segment define a passage volume therebetween.

8. The aircraft of claim 7, wherein the aircraft comprises one or more propulsion units that are operatively coupled to the forward wing segment, and wherein the passage volume is configured to channel slipstreams generated by the one or more propulsion units.

9. The aircraft of claim 7, wherein the passage volume is configured to direct airflow across an upper surface of the forward wing segment and prevent airflow separation from the upper surface of the forward wing segment.

10. The aircraft of claim 1, wherein a trailing edge region of the forward wing segment and a leading edge region of the rear wing segment overlap when the wing assembly is in the forward thrust configuration.

11. The aircraft of claim 1, wherein a trailing edge region of the forward wing segment is positioned proximate to a leading edge region of the rear wing segment when the wing assembly is in the forward thrust configuration.

12. The aircraft of claim 1, wherein the wing assembly comprises one or more transition panels that are configured to form one or more smooth transition surfaces between the rear wing segment and the forward wing segment when the wing assembly is in the forward thrust configuration.

13. The aircraft of claim 12, wherein the one or more transition panels are configured to be selectively and operatively retracted from operative contact with the rear wing segment when the wing assembly is selectively transitioned from the forward thrust configuration to among the plurality of pitched thrust configurations, and wherein the one or more transition panels are configured to be selectively and operatively extended to operatively contact the rear wing segment when the wing assembly is selectively and operatively transitioned to the forward thrust configuration from among the plurality of pitched thrust configurations.

14. The aircraft of claim 1, wherein the aircraft further comprises one or more propulsion units operatively coupled to the airframe that are configured to supply thrust to the aircraft when the wing assembly is in the forward thrust configuration and when the wing assembly is among the plurality of pitched thrust configurations.

15. The aircraft of claim 14, wherein the one or more propulsion units are operatively coupled to the forward wing segment, wherein the one or more propulsion units are configured to be tilted with the forward wing segment among the plurality of forward wing segment tilt positions, and wherein the one or more propulsion units are configured to supply thrust to the aircraft along a plurality of thrust vectors that correspond to the plurality of forward wing segment tilt positions.

16. The aircraft of claim 1, wherein the wing assembly defines a frontal area when the wing assembly is among the plurality of pitched thrust configurations, wherein the frontal area of the wing assembly is smaller than a sum of frontal areas defined by the forward wing segment and the rear wing segment.

17. The aircraft of claim 1, wherein the wing assembly further comprises one or more additional rear wing segments that are positioned within the wing assembly rearwardly of the rear wing segment, and wherein the one or more additional rear wing segments are configured to define the continuous airfoil shape with the forward wing segment and the rear wing segment when the wing assembly is oriented among the plurality of pitched thrust configurations.

18. The aircraft of claim 1, wherein each additional rear wing segment is configured to be selectively tilted among a plurality of additional rear wing segment tilt positions, wherein the plurality of additional rear wing segment tilt positions comprises an additional rear wing segment forward thrust position that corresponds to the forward thrust configuration of the wing assembly and a plurality of additional rear wing segment pitched thrust positions that correspond to the plurality of pitched thrust configurations of the wing assembly.

19. An aircraft comprising:
an airframe comprising a wing assembly that includes a forward wing segment and a rear wing segment, wherein the forward wing segment is positioned within the airframe forward of at least a portion of the rear wing segment, and wherein the wing assembly is configured to be selectively transitioned among:
(i) a forward thrust configuration in which the forward wing segment and the rear wing segment define a continuous airfoil shape; and
(ii) a plurality of pitched thrust configurations in which the forward wing segment and at least the portion of the rear wing segment are spaced apart and the forward wing segment and the rear wing segment define discrete airfoil shapes;
wherein the forward wing segment is pivotally coupled within the airframe and configured to be selectively tilted among a plurality of forward wing segment tilt positions, wherein the plurality of forward wing segment tilt positions comprises a forward wing segment forward thrust position and a plurality of forward wing segment pitched positions, wherein the forward wing segment forward thrust position corresponds to the forward thrust configuration of the wing assembly and the plurality of forward wing segment pitched positions corresponds to the plurality of pitched thrust configurations of the wing assembly;
wherein the rear wing segment is pivotally coupled within the airframe and configured to be selectively tilted among a plurality of rear wing segment tilt positions, wherein the plurality of rear wing segment tilt positions comprises a rear wing segment forward thrust position and a plurality of rear wing segment pitched positions, wherein the rear wing segment forward thrust position corresponds to the forward thrust configuration of the wing assembly and the plurality of rear wing segment pitched positions corresponds to the plurality of pitched thrust configurations of the wing assembly; and
a plurality of propulsion units operatively coupled to the forward wing segment that are configured to supply thrust to the aircraft when the wing assembly is in the forward thrust configuration and when the wing assembly is among the plurality of pitched thrust configurations, wherein the plurality of propulsion units are configured to be tilted with the forward wing segment among the plurality of forward wing segment tilt positions, and wherein the plurality of propulsion units are configured to supply thrust to the aircraft along a plurality of thrust vectors that correspond to the plurality of forward wing segment tilt positions.

20. A method of operating an aircraft that comprises a wing assembly having a forward wing segment and a rear wing segment, the method comprising:
controlling elevation of the aircraft by controlling vectored thrust induced in the aircraft by one or more propulsion units; and
transitioning the aircraft to a cruise configuration by:
(i) selectively tilting the forward wing segment from a forward wing segment pitched position to a forward wing segment forward thrust position in which the forward wing segment and the rear wing segment define a continuous airfoil shape; and
(ii) supplying thrust to the aircraft with the one or more propulsion units in a forward thrust vector that corresponds to the forward wing segment forward thrust position.
